(19) United States
(12) Patent Application Publication
(10) Pub. No.: US 2013/0177020 A1
(43) Pub. Date: Jul. 11, 2013

(54) COMMUNICATION APPARATUS AND CONTROL METHOD

(71) Applicant: FUJITSU LIMITED, Kawasaki-shi (JP)

(72) Inventor: Keiji MIYAZAKI, Kawasaki (JP)

(21) Appl. No.: 13/671,615

(22) Filed: Nov. 8, 2012

(30) Foreign Application Priority Data
Jan. 5, 2012 (JP) 2012-000568

(51) Int. Cl. H04L 12/56

(52) U.S. Cl. CPC H04L 45/74
USPC 370/392

(57) ABSTRACT

Each edge switch counts the number of times that a first-arrival packet of the same packets was received for each port, and after a predetermined time elapsed, a main edge switch that is determined based on the transmission source and destination MAC addresses identifies a port based on the number of times, and registers the identified port in a table of the main edge switch with the transmission source MAC address. On the other hand, a sub-edge switch clears the number of times once after the predetermined time elapsed, and counts the number of times again. After that, when the predetermined time elapsed again, similar to the main edge switch, the sub-edge switch identifies a port based on the number of times, and registers the identified port in a table of the sub-edge switch with the transmission source MAC address.

### CROSS-REFERENCE TO RELATED APPLICATIONS

This application is based upon and claims the benefit of priority of the prior Japanese Patent Application No. 2012-000568, filed on Jan. 5, 2012, the entire contents of which are incorporated herein by reference.

### FIELD

This technique relates to a technique for determining an output destination port of a packet.

### BACKGROUND

In a conventional technique, as illustrated in FIG. 1, when continuously transmitting packets from a terminal A to a terminal B via a network that includes switches N1 to N4, an edge switch N1 on the terminal A side initially carries out flooding to transmit the same packets through paths A and B. As a result, an edge switch N4 on the terminal B side receives the same packets at both input ports p1 and p3, and the number of first-arrival packets that arrived first is counted for each port. The same packets other than the first-arrival packets are discarded at the switch N4. Then, at a certain timing, the terminal B selects an input port for which the number of first-arrival packets is the greatest as the first-arrival port, then registers that port in association with the MAC address of the terminal A (or in other words, the transmission source) in a MAC table. In doing so, after that, when transmitting packets from the terminal B to the terminal A, the MAC address of the terminal A and the output destination port are correlated in the MAC table, so the output destination port that is the first-arrival port is identified, and packets are outputted to that output destination port. For example, when the number of first-arrival packets for the path A is greater, the port p1 of the path A is registered in the MAC table of the edge switch N4, and packets are transmitted by way of the same path as the path A, even when transmitting packets in the opposite direction such as when transmitting packets from the terminal B to the terminal A.

However, unity of communication paths in both directions is established in a condition such as when one-direction transmission of packets, in which the packets are continuously transmitted from the terminal A to the terminal B, is continuously carried out first.

More specifically, when the terminal A and terminal B start packet transmission nearly simultaneously in both directions, trouble occurs. In other words, it is assumed that, when transmitting packets from the terminal A to the terminal B, the number of first-arrival packets for the path A is greater, however, when transmitting packets from the terminal B to the terminal A, conversely, the number of first-arrival packets for the path B is greater. As a result, the port p2 for the path B is registered in the MAC table of the edge switch N1, and packets are transmitted via the same path as the path B even when transmitting packets in the opposite direction such as when transmitting packets from the terminal A to the terminal B. Here, in the packet transmission from the terminal A to the terminal B, the path B is selected even though the number of first-arrival packets for the path A was greater, and in the packet transmission from the terminal B to the terminal A, the path A is selected even though the number of first-arrival packets for the path B was greater.

When other packets that include a combination of a transmission source address and transmission destination address, which is the same as the combination of transmission source address and transmission destination address of the first-arrival packet arrive at an input port other than the input port where the first-arrival packet arrived, a mechanism may be included, which discards that other packets. In this case, in a situation as described above, a situation occurs in which all packets in both directions are discarded.

Conventionally, no technique has existed for handling a case where communication paths do not match, or where all packets are discarded in this way.

In other words, there is no technique for enabling to appropriately carry out communication through the same communication path in the both directions.

### SUMMARY

A communication apparatus relating to a first aspect of this technique includes: plural input ports; plural output ports, each of which corresponds to one different input port of the plural input ports; a memory storing first relation information, in which a transmission destination address and an identifier of an output port of an output destination are associated, and second relation information, in which a transmission destination address, a transmission source address, an identifier of an input port and the number of reception times; and a packet processing unit that identifies an identifier of an output port, which is associated with a transmission destination address of a received packet from any one input port of the plural input ports in the first relation information, and causes the received packet to be outputted to the output port of the identified identifier. Then, (A) upon receiving same packets at different input ports, the packet processing unit updates, in the second relation information, the number of reception times, which is associated with a transmission source address and a transmission destination address for the same packets and an identifier of an input port at which an earliest packet of the same packets arrived. Moreover, (B) upon detecting that a first timing condition is satisfied and in case where the communication apparatus is a first edge communication apparatus of two edge communication apparatuses associated with a transmission source address and a transmission destination address of a first received packet, the packet processing unit identifies an identifier of an input port based on the number of reception times, which is associated with the transmission source address and the transmission destination address of the first received packet in the second relation information, and updates the first relation information with an identifier of an output port corresponding to the identified identifier of the input port and the transmission source address of the first received packet. Furthermore, (C) upon detecting that the first timing condition is satisfied and in case where the communication apparatus is a second edge communication apparatus of the two edge communication apparatuses, the packet processing unit sets zero as the number of reception times, which is associated with the transmission source address and the transmission destination address of the first received packet in the second relation information. In addition, (D) upon detecting that a second timing condition is satisfied after the first timing condition is satisfied, in response to receipt of a second packet including the same transmission source address and the same transmission destination address of the first received packet, the packet processing unit identifies an identifier of an input port based on the number of reception times, which is associated with the transmission source address and the transmission destination address of the second packet in the second relation information, and updates the first relation information with an identifier of an output port corresponding to the identified identifier of the input port and the transmission source address of the second packet.

A communication apparatus relating to a second aspect of this technique includes: plural input ports; plural output ports, each of which corresponds to one different input port of the plural input ports; a memory storing first relation information, in which a transmission destination address and an identifier of an output port of an output destination are associated, and second relation information, in which a transmission destination address, a transmission source address, an identifier of an input port and the number of reception times; and a packet processing unit that identifies an identifier of an output port, which is associated with a transmission destination address of a received packet from any one input port of the plural input ports in the first relation information, and causes the received packet to be outputted to the output port of the identified identifier. Then, (A) in case where the communication apparatus is a first edge communication apparatus of two edge communication apparatuses associated with a transmission source address and a transmission destination address of first received packets, the packet processing unit registers an identifier of an output port, which corresponds to an identifier of an input port at which an earliest packet of the first received packets arrived in the first relation information in association with the transmission source address of the first received packets, even when the first received packets are identical. Moreover, (B) in case where the communication apparatus is a second edge communication apparatus of the two edge communication apparatuses, the packet processing unit updates the number of reception times, which is associated in the second relation information with the transmission source address and the transmission destination address of the first received packets and an identifier of an input port at which one of the first received packets arrived, even when the first received packets are identical. In addition, (C) upon detecting that a first timing condition is satisfied, the packet processing unit identifies an identifier of an input port based on the number of reception times, which is associated with the transmission source address and the transmission destination address of the first received packets in the second relation information, and updates the first relation information with an identifier of an output port, which corresponds to the identified identifier of the input port and the transmission source address of the first received packets.

A communication apparatus relating to a third aspect of this technique includes: plural input ports; plural output ports, each of which corresponds to one different input port of the plural input ports; a memory storing first relation information, in which a transmission destination address and an identifier of an output port of an output destination are associated, second relation information, in which a transmission destination address, a transmission source address, an identifier of an input port and the number of discarding times, and third relation information, in which a transmission source address, a transmission destination address and an identifier of an input port; and a packet processing unit that identifies an identifier of an output port, which is associated with a transmission destination address of a received packet from any one input port of the plural input ports in the first relation information, and causes the received packet to be outputted to the output port of the identified identifier. Then, (A) upon detecting that a received packet arrived at an input port different from an input port, which is associated with a transmission source address and a transmission destination address of the received packet in the third relation information, the packet processing unit discards the received packet, and updates the number of discarding times, which is associated in the second relation information with the transmission source address and the transmission destination address of the received packet and an identifier of an input port at which the received packet arrived. Moreover, (B) upon detecting that the number of discarding times exceeds a threshold and in case where the communication apparatus is a first edge communication apparatus, which is identified based on a comparison result between a transmission source address and a transmission destination address of a discarded packet, among two edge communication apparatuses associated with the transmission source address and the transmission destination address of the discarded packets, the packet processing unit deletes information concerning the transmission source address and the transmission destination address of the discarded packet in the third relation information, at least the number of discarding times, which is associated in the second relation information, with the transmission source address and the transmission destination address of the discarded packet, and information concerning the transmission source address of the discarded packet in the first relation information.

A communication apparatus relating to a fourth aspect of this technique includes: plural input ports; plural output ports, each of which corresponds to one different input port of the plural input ports; and a memory storing first relation information, in which a transmission destination address and an identifier of an output port of an output destination are associated, second relation information, in which a transmission destination address, a transmission source address, an identifier of an input port and the number of discarding times, and third relation information, in which a transmission source address, a transmission destination address and an identifier of an input port; and a packet processing unit that identifies an identifier of an output port, which is associated with a transmission destination address of a received packet from any one input port of the plural input ports in the first relation information, and causes the received packet to be outputted to the output port of the identified identifier. Then, (A) upon detecting that a received packet arrived at an input port different from an input port, which is associated with a transmission source address and a transmission destination address of the received packet in the third relation information, the packet processing unit discards the received packet, and updates the number of discarding times, which is associated in the second relation information with the transmission source address and the transmission destination address of the received packet and an identifier of an input port at which the received packet arrived. Moreover, (B) upon detecting the number of discarding times exceeds a threshold and in case where the communication apparatus is a first edge communication apparatus, which is identified based on a comparison result between a transmission source address and a transmission destination address of a discarded packet, among two edge communication apparatuses associated with the transmission source address and the transmission destination address of the discarded packets, the packet processing unit discards at least the number of discarding times, which is associated with the transmission source address and the transmission destination address of the discarded packet in the second relation information, registers an identifier of an output port, which corresponds to an identifier of an input port at which the discarded packet arrived, in association with the transmission source address of the discarded packet in the first relation information, and registers the identifier of the output port, which corresponds to the identifier of the input port at which the discarded packet arrived, in association with the transmission source address and the transmission destination address of the discarded packet in the third relation information.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain conventional arts;

FIG. 2A is a diagram to explain a processing relating to a first embodiment;

FIG. 2B is a diagram to explain a processing relating to the first embodiment;

FIG. 3 is a diagram depicting a configuration example of a switch relating to the first embodiment;

FIG. 4 is a diagram depicting an example of a first table;

FIG. 5 is a diagram depicting an example of a second table;

FIG. 6 is a diagram depicting an example of a third table;

FIG. 7 is a diagram depicting a processing flow relating to the first embodiment;

FIG. 8 is a diagram depicting a processing flow of a first-arrival learning processing;

FIG. 9 is a diagram depicting a processing flow relating to a second embodiment;

FIG. 10 is a diagram depicting an example of a first table in a third embodiment;

FIG. 11 is a diagram depicting a processing flow relating to the third embodiment;

FIG. 12A is a diagram to explain a fourth embodiment;

FIG. 12B is a diagram to explain the fourth embodiment;

FIG. 12C is a diagram to explain the fourth embodiment;

FIG. 12D is a diagram to explain the fourth embodiment;

FIG. 13 is a diagram depicting a configuration example of a switch relating to the fourth embodiment;

FIG. 14 is a diagram depicting an example of a fourth table;

FIG. 15 is a diagram depicting an example of a fifth table;

FIG. 16 is a diagram depicting a processing flow relating to the fourth embodiment;

FIG. 17 is a diagram depicting a processing flow relating to a fifth embodiment;

FIG. 18 is a diagram depicting an example of a fourth table relating to a sixth embodiment;

FIG. 19 is a diagram depicting a processing flow relating to the sixth embodiment;

FIG. 20 is a diagram depicting a processing flow relating to a seventh embodiment; and

FIG. 21 is a functional block diagram of a computer functioning a switch.

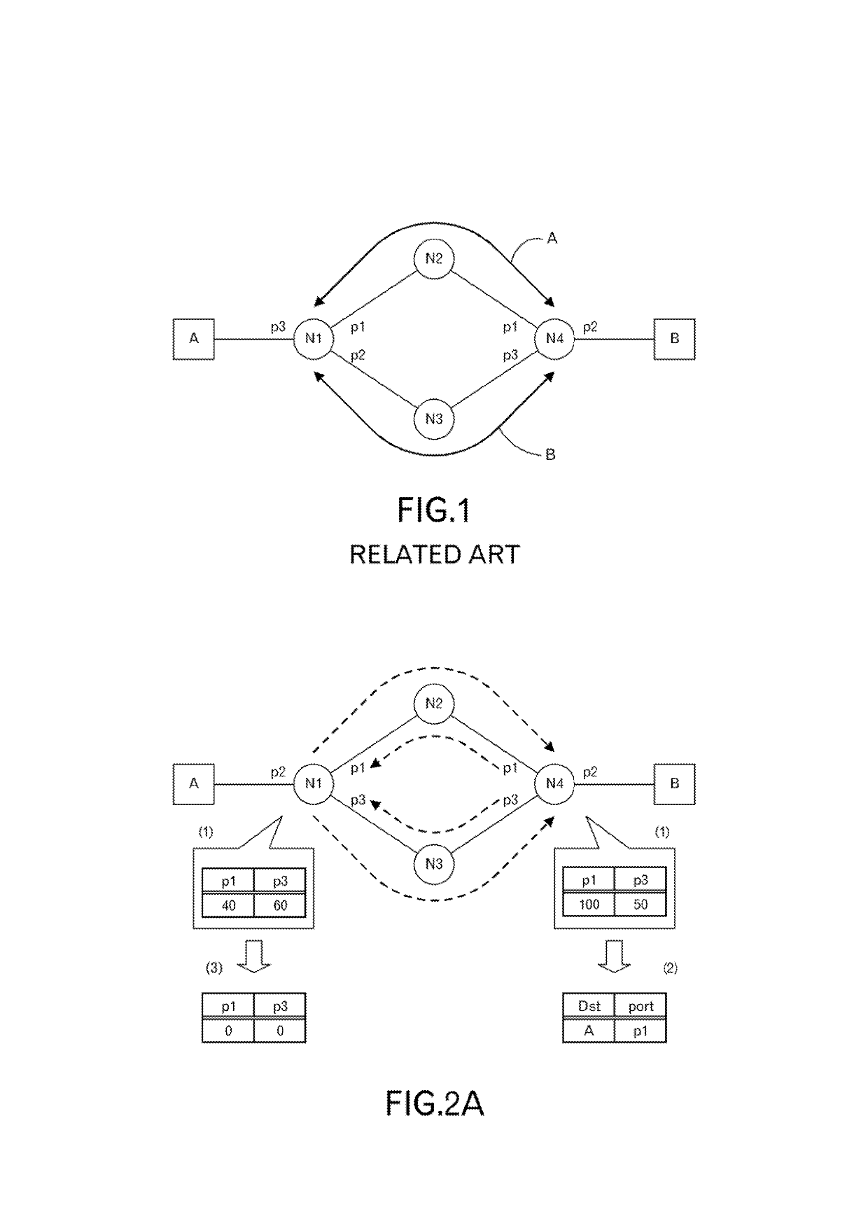

### DESCRIPTION OF EMBODIMENTS

### Embodiment 1

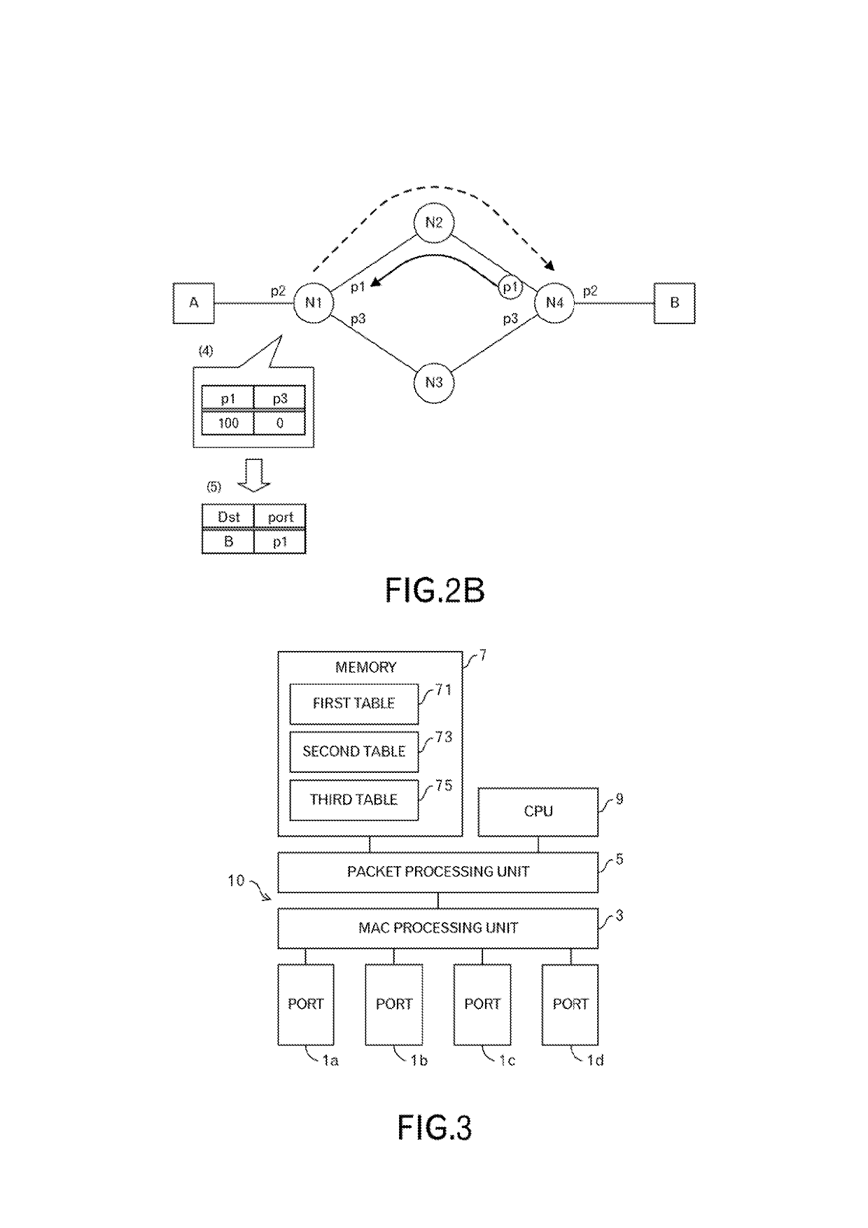

In this embodiment, a processing such as illustrated in FIG. 2A and FIG. 2B is carried out. First, a network having switches N1 to N4 is provided between terminal A and terminal B, where an edge switch on the terminal A side is the switch N1, and an edge switch on the terminal B side is the switch N4. Between the terminal A and the terminal B, there is a first path via the switches N1, N2 and N4, and a second path via the switches N1, N3 and N4. In such a network configuration, it is presumed that the terminal A and terminal B carry out packet transmission at nearly the same time from the terminal A to the terminal B and from the terminal B to the terminal A. Initially, in any one of the switches N1 and N4, no association between a transmission destination MAC address and a port number is registered in the MAC learning table, so flooding (simultaneous transmission) is performed; and as illustrated by the dotted line in FIG. 2A, packet transmission is carried out in both directions using both the first path and the second path.

In such a case, when the switch N4 receives the same packets at the port p1 and port p3, only the first-arrival packet that arrived the earliest is outputted to the port p2, and the packet that arrived later is discarded. The number of first-arrival packets is counted for the ports p1 and p3. Similarly, when the switch N1 receives the same packets at the port p1 and port p3, only the first-arrival packet that arrived first is outputted to the port p2, and the packet that arrived later is discarded. Then, the number of times that first-arrival packets are received is counted for the port p1 and port p3 (step (1)). When a packet is received once from the other party side, that transmission source MAC address and port number are temporarily registered in a MAC learning table, and next, when a first-arrival packet arrives at another port, the port number in the MAC learning table is changed. In other words, the output destination port is not fixed.

After a certain amount of time elapses, as illustrated in the balloons in FIG. 2A, it can be seen that, for the switch N4, the number of times that the first-arrival packets were received at the port p1 is greater than the number of times that the first-arrival packets were received at the port p3. Also, it can be seen that, for the switch N1, the number of times that first-arrival packets were received at the port p3 is greater than the number of times that the first-arrival packets were received at the port p1.

Here, when comparing the MAC address of the terminal B with the MAC address of the terminal A, it is assumed that the MAC address of the terminal B is greater, and in such a case, the edge switch N4 on the terminal B side is given priority. Then, the switch N4 finally registers the port p1, which had the greater number of first-arrival packets as described above, in association with the transmission source MAC address in the MAC learning table (step (2)). On the other hand, the edge switch N1 on the terminal A side clears the counted number of times that the first-arrival packets were received at the step (1), and starts the counting again (step (3)).

As a result, after the step (3), as illustrated in FIG. 2B, when transmitting packets from the terminal B to the terminal A, the switch N4 outputs the packets from the terminal B to the port p1 according to the MAC learning table (step (4)). In other words, packets are only transmitted by the first path. On the other hand, because the switch N1 does not finally registers any entry in the MAC learning table yet, packets from the terminal A to the terminal B are transmitted through the first path or the second path. However, packets that arrived at the switch N1 are received only by the port p1. After a certain amount of time elapses, as illustrated in the balloon in FIG. 2B, the number of times that the first-arrival packets were received at the port p1 is greater than the number of times that the first-arrival packets were received at the port p3, so after the step (3), the switch N1 finally registers the port p1 for which the number of times that the first-arrival packets were received is greater as described above in the MAC learning table in association with the transmission source MAC address (step (5)).

In doing so, the communication path for either direction is unified to the first path.

Next, FIG. 3 illustrates a configuration example of a switch that is used to carry out the processing described above. A switch 10 in this embodiment has plural ports 1, each of which includes an input port and output port (four ports 1a, 1b, 1c and 1d in FIG. 3), a MAC processing unit 3, a packet processing unit 5, a memory 7 and a CPU (Central Processing Unit) 9.

Each port 1 is connected to a cable for connecting to another device, and carries out a processing for received packets and packets to be transmitted such as signal waveform conversion, serial conversion, frame encoding and the like. The MAC processing unit 3 carries out a MAC frame processing. The CPU 9 carries out a processing for various protocols. Such a processing is the same as conventionally performed, so no more explanation will be given.

The packet processing unit 5 carries out a main portion of the processing explained using FIG. 2A and FIG. 2B, and carries out a packet transfer processing to identify the output port from the transmission destination MAC address to output packets. The memory 7 stores a first table 71 for counting the number of times that first-arrival packets were received for each port (also called a learning table for each port), a second table 73 that stores correlations between the transmission destination MAC address and port identifier (also called a MAC learning table), and a third table 75 that stores correlations among the transmission source MAC address, transmission destination MAC address, FCS (Frame Check Sequence) and the reception time (also called a first-arrival learning table).

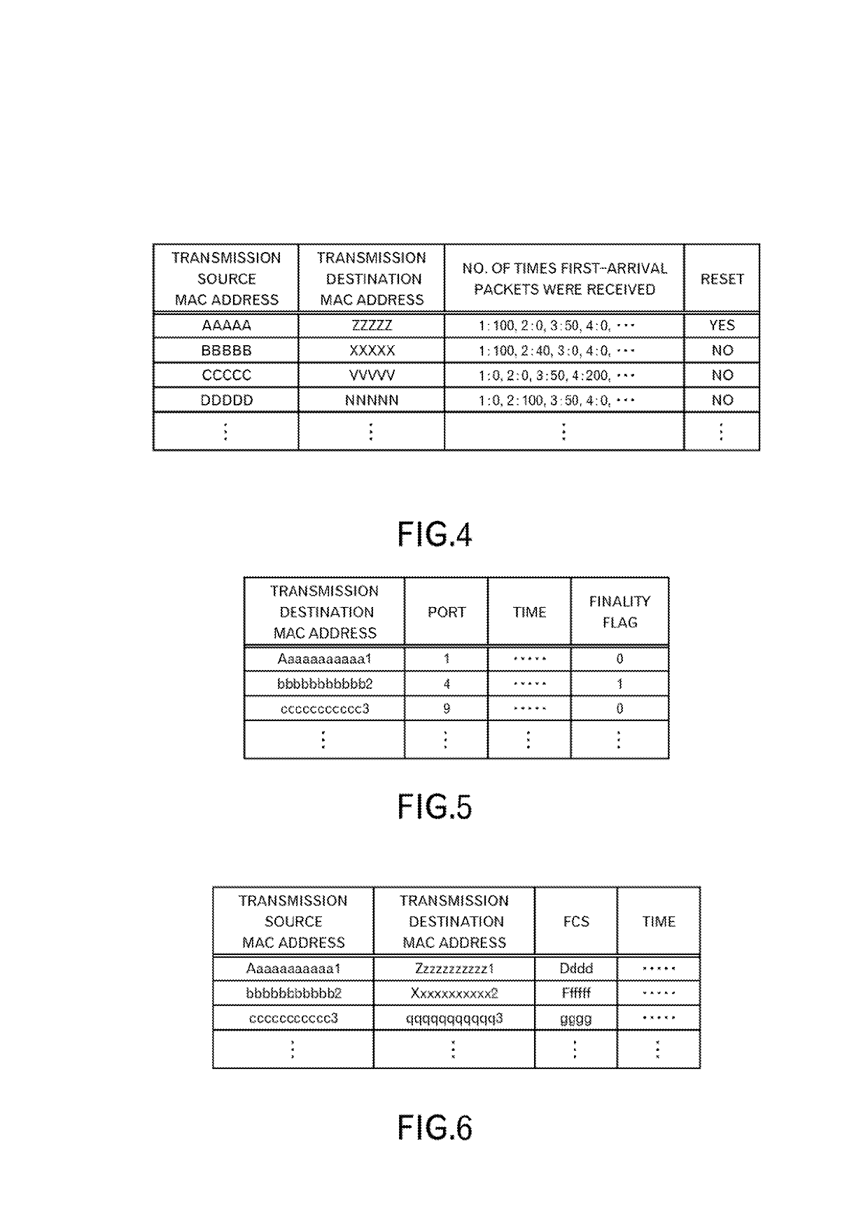

The first table 71 is a table such as illustrated in FIG. 4. In the example in FIG. 4, for each combination of the transmission destination MAC address and transmission source MAC address, the number of times that the first-arrival packets have been received for each port and whether or not the number has been reset are registered. For example, FIG. 4 represents that the first-arrival packets from AAAAA to ZZZZZ have been received 100 times for the port 1, 0 times for the port 2, 50 times for the port 3 and 0 times for the port 4. In some cases, the reception time of the earliest first-arrival packet may be further registered.

Moreover, the second table 73 is a table such as illustrated in FIG. 5. In the example in FIG. 5, the port identifier, the setting time, and a finality flag are registered in association with the transmission destination MAC address. The finality flag is “0” when it is not finalized, and “1” when it is finalized. However, other values to express being finalized or not finalized may be used. Whether finalized or not finalized may not be positively represented.

Furthermore, the third table 75 is a table such as illustrated in FIG. 6. In the example in FIG. 6, a combination of the transmission source MAC address and transmission destination MAC address, an FCS of the first-arrival packet and the reception time of that first-arrival packet are registered.

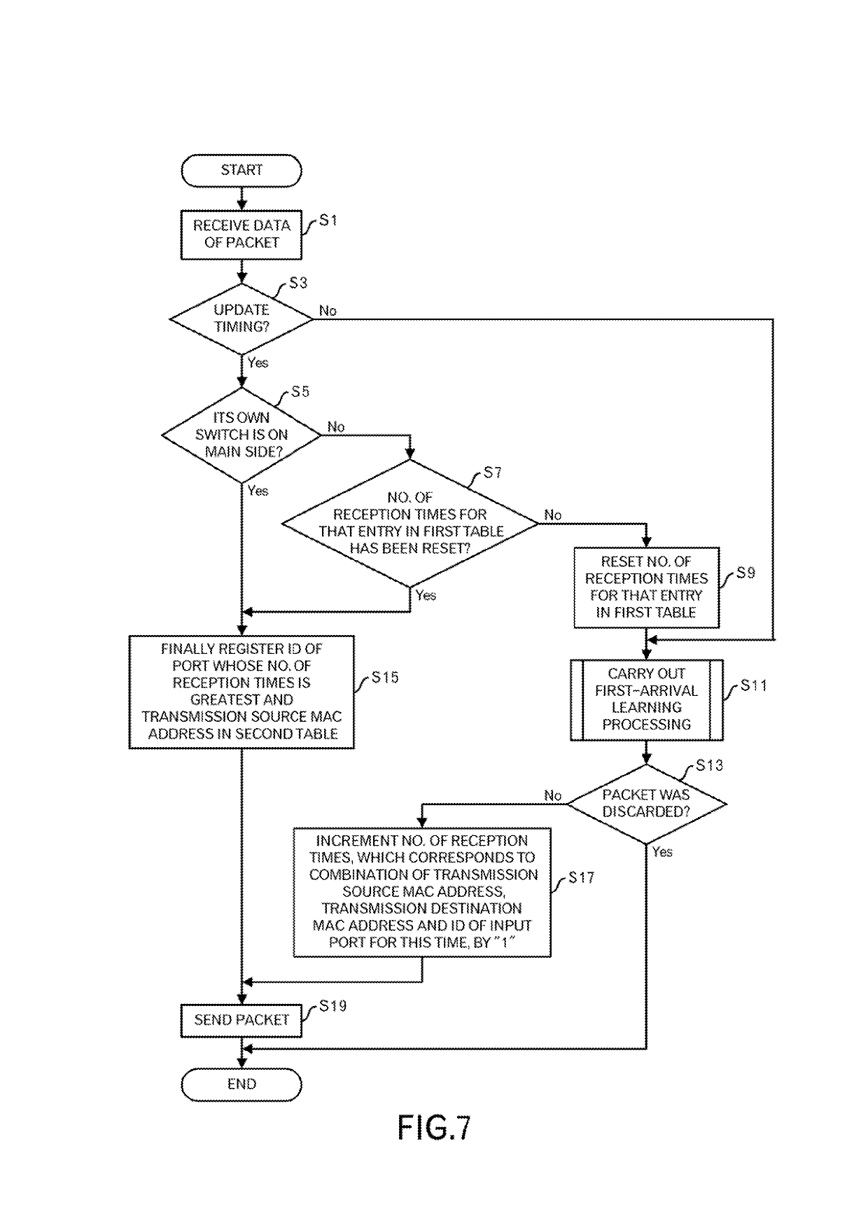

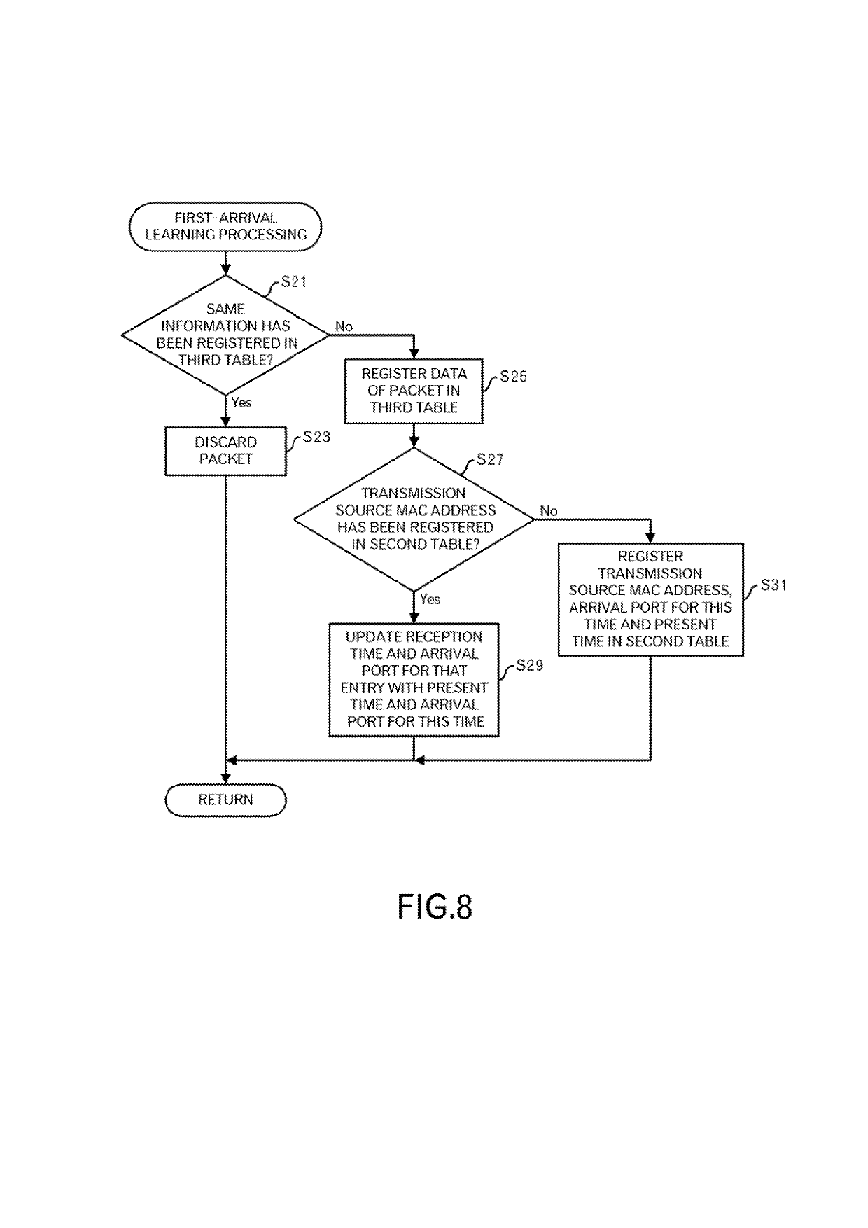

Next, the processing executed by the packet processing unit 5 and the like will be explained using FIG. 7 and FIG. 8. Data of a packet that is received by any one of the ports 1 is outputted to the packet processing unit 5 by way of the port 1 and the MAC processing unit 3. Not only the packet data itself but also the identifier of the input port where the packet arrived is included in the data of the packet.

When receiving the data of the packet from the MAC processing unit 3 (FIG. 7: step S1), the packet processing unit 5 identifies an entry, which is registered in the first table 71, by using the transmission source MAC address and transmission destination MAC address for that packet, and determines whether or not this timing is an update timing to update the second table 73 (step S3). For example, the packet processing unit 5 determines from the identified entry whether or not the total number of times that the first-arrival packets have been received for respective ports has reached a threshold value or greater. When the reception time for the earliest first-arrival packet is registered in the first table 71, the packet processing unit 5 determines whether or not a predetermined amount of time has elapsed since that reception time.

When this timing is not update timing, the packet processing unit 5 carries out a first-arrival learning processing (step S11). FIG. 8 will be used to explain the first-arrival learning processing.

The packet processing unit 5 determines whether or not the same information has already been registered in the third table 75 (FIG. 8: step S21). More specifically, the packet processing unit 5 determines whether or not an entry having the same transmission destination MAC address, transmission source MAC address and FCS has already been registered in the third table 75. In other words, the packet processing unit 5 determines whether or not that same packet was received again by another port.

When the same information has already been registered in the third table 75, the packet processing unit 5 discards the packet that was received this time (step S23). Then, the processing returns to the calling source processing.

On the other hand, when the same information has not been registered in the third table 75, the packet processing unit 5 registers the data of the packet that was received this time in the third table 75 (step S25).

The packet processing unit 5 then determines whether or not the transmission source MAC address has already been registered in the second table 73 (step S27). When the transmission source MAC address has already been registered, the packet processing unit 5 updates the reception time and identifier of the arrival port in the entry of that transmission source MAC address (that pertinent entry) with the current time and the identifier of the arrival port for this time in the second table 73 (step S29). At this time, the finality flag is “0”. The processing then returns to the calling source processing.

On the other hand, when the transmission source MAC address has not already been registered in the second table 73, the packet processing unit 5 registers the transmission source MAC address, the identifier of the arrival port for this time and the current time in the second table 73 as a new entry (step S31). At this time as well, the finality flag is “0”. The processing then returns to the calling source processing.

The second table 73 is updated in this way, however, in this processing, the updated entry is not finalized.

Returning to the explanation of the processing illustrated in FIG. 7, the packet processing unit 5 determines whether or not the packet was discarded in the first-arrival learning processing (step S13), and when the packet was discarded, the processing ends.

On the other hand, when the packet was not discarded, the packet processing unit 5 increments, by “1”, the number of reception times in the first table 71, which corresponds to the transmission source MAC address, the transmission destination MAC address and the identifier of the input port for this time (step S17). The packet processing unit 5 then searches the second table 73 for the transmission destination MAC address of the received packet, and when a port identifier is correlated in the second table 73 with the transmission destination MAC address, the packet processing unit 5 outputs the data of that packet by way of the MAC processing unit 3 so that the packet is outputted from the port of that port identifier (step S19). However, when there is no entry for the transmission destination MAC address in the second table 73, the packet processing unit 5 outputs the data of that packet by way of the MAC processing unit 3 so that the packet is outputted to other ports other than the current arrival port. The processing then ends.

By repeating such a processing, the number of reception times of the first-arrival packets is registered for each port in the first table 71 as illustrated in FIG. 4.

Then, when it was determined at the step S3 that the timing is the update timing, or in other words, when the total number of times that the first-arrival packets for the respective ports have been received reaches the threshold value or greater, or when the reception time of the earliest first-arrival packet has been registered and a predetermined amount of time has elapsed since that reception time, the packet processing unit 5 determines whether or not its own switch is on the main side (step S5). For example, the packet processing unit 5 compares the transmission source MAC address X with the transmission destination MAC address Y, and when the transmission source MAC address X is greater than the transmission destination MAC address Y, the packet processing unit 5 determines that its own switch is on the main side. The switch 10 on the sub side compares the transmission source MAC address Y with the transmission destination MAC address X, and then it is determined that the aforementioned condition is not satisfied, and it is determined that the switch is on the sub side.

When the switch is on the main side, the packet processing unit 5 finally registers an identifier of a port for which the number of reception times, which is correlated with the transmission destination MAC address and transmission source MAC address of the received packet in the first table 71, is the greatest, in association with the transmission source MAC address in the second table 73 (step S15). As a result, for the switch 10 on the main side, the output destination port is fixed to the port having the greatest number of reception times. The processing then moves to step S19.

On the other hand, in the case of the switch 10 on the sub side, the packet processing unit 5 determines whether or not the number of reception times for that entry in the first table 71 has already been reset before (step S7). This is determined from the value in the column of the presence or absence of the reset for that entry in the first table 71. When the number of reception times for that entry has already been reset before, the processing moves to step S15. On the other hand, when the number of reception times for that entry has never been reset before, the packet processing unit 5 clears the number of reception times for that entry to “0” in the first table 71 (step S9). Here, “Yes” is set as the value in the column of the presence or absence of the reset for that entry in the first table 71. The processing then moves to step S11.

By carrying out the processing described above, the processing such as illustrated in FIG. 2A and FIG. 2B is carried out.

### Embodiment 2

In this embodiment, part of the processing in the embodiment 1 is changed. The basic configuration of the switch 10 is the same, and the processing contents carried out by the packet processing unit 5 are partially different.

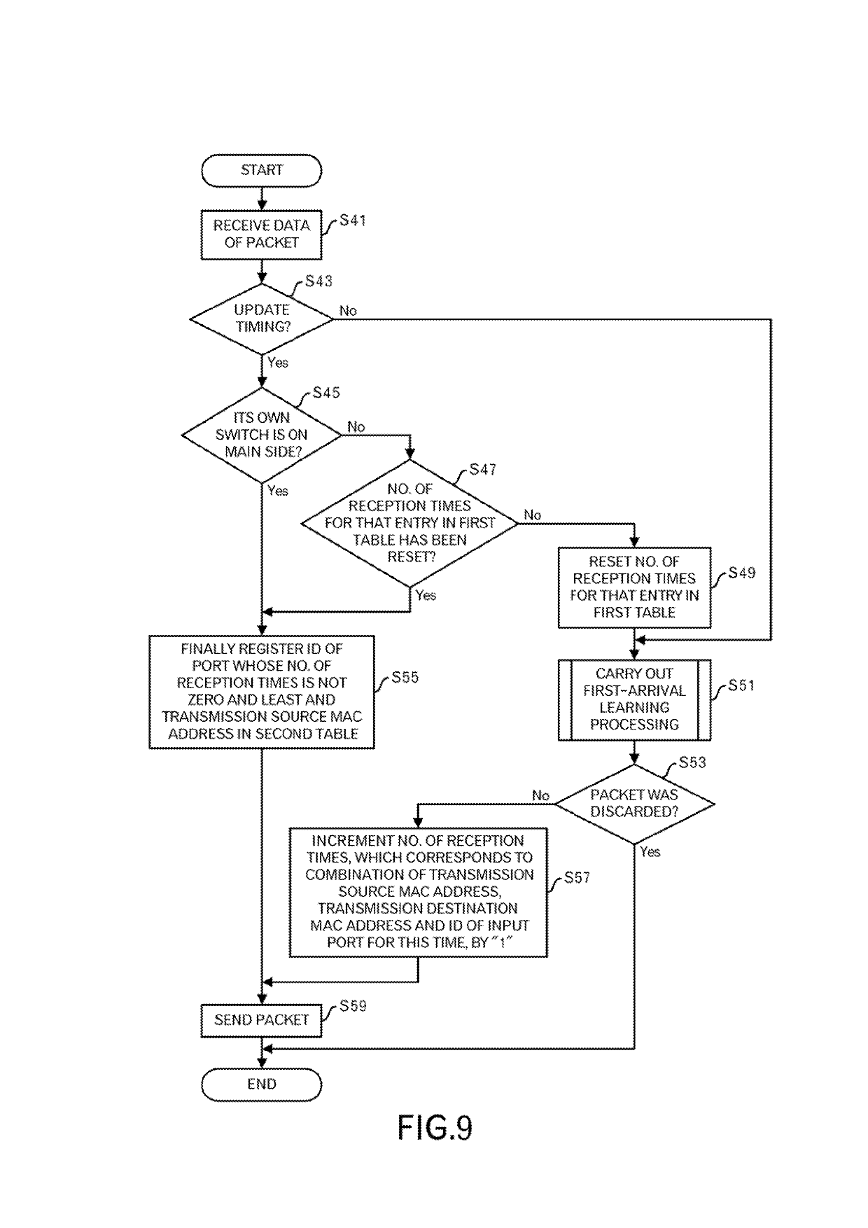

A processing carried out by the packet processing unit 5 and the like will be explained using FIG. 9.

When receiving data of the packet from the MAC processing unit 3 (FIG. 9: step S41), the packet processing unit 5 identifies an entry that is registered in the first table 71 by using the transmission destination MAC address and transmission source MAC address of that packet, and determines whether or not this timing is an update timing to update the second table 73 (step S43). For example, the packet processing unit 5 determines from the identified entry whether or not the total number of times that the first-arrival packets have been received for the respective ports has reached a threshold value or greater. When the reception time of the earliest first-arrival packet has been registered, the packet processing unit 5 determines whether or not a predetermined amount of time has elapsed since that reception time.

When the timing is not update timing, the packet processing unit 5 carries out the first-arrival learning processing (step S51). The first-arrival learning processing is the same as the processing in FIG. 8, so an explanation is omitted.

After the first-arrival learning processing, the packet processing unit 5 determines whether or not the packet was discarded in the first-arrival learning processing (step S53), and when the packet was discarded, the processing ends.

On the other hand, when the packet was not discarded, the packet processing unit 5 increments, by “1”, the number of reception times in the first table 71, which corresponds to the transmission source MAC address, transmission destination MAC address and the identifier of the input port for this time (step S57). Then, the packet processing unit 5 searches the second table 73 for the transmission destination MAC address of the received packet, and when there is a port identifier in the second table 73, which is correlated with the transmission destination MAC address, the packet processing unit 5 outputs the data of that packet by way of the MAC processing unit 3 so that the packet is outputted from that port of the port identifier (step S59). However, when there is no entry in the second table 73 for the transmission destination MAC address, the packet processing unit 5 outputs the data of that packet by way of the MAC processing unit 3 so that the packet is outputted to other ports other than the current arrival port. The processing then ends.

By repeating such a processing, the number of times that first-arrival packets have been received is registered for each port in the first table 71 as illustrated in FIG. 4.

When it was determined at the step S43 that the timing is the update timing, or in other words, when the total number of times that the first-arrival packets have been received for the respective ports has reached a threshold value or greater, or when the reception time of the earliest first-arrival packet has been registered and a predetermined amount of time has elapsed since that reception time, the packet processing unit 5 determines whether or not its own switch is on the main side (step S45). For example, the packet processing unit 5 compares, for example, the transmission source MAC address X with the transmission destination MAC address Y, and when the transmission source MAC address X is greater than the transmission destination MAC address Y, the packet processing unit 5 determines that the switch is on the main side. The switch 10 on the sub side compares the transmission source MAC address Y with the transmission destination MAC address X, and then it is determined that the aforementioned condition is not satisfied, and the switch is recognized as being on the sub side.

When the switch is on the main side, the packet processing unit 5 finally registers the identifier of the port whose number of reception times is the least and is not zero in association with the transmission source MAC address, in the second table 73 (step S55). As a result, as for the switch 10 on the main side, the output destination port is fixed to the port whose number of reception times is the least and is not zero. In doing so, a port for which congestion does not occur easily is selected and used. The processing then moves to step S59.

On the other hand, in the case of the switch 10 on the sub side, the packet processing unit 5 determines whether or not the number of reception times for that entry in the first table 71 has already been reset before (step S47). This is determined from the value in the column of the presence or absence of the reset for that entry in the first table 71. When the number of reception times for that entry has already been reset before, the processing moves to step S55. On the other hand, when the number of reception times for that entry has not been reset before, the packet processing unit 5 clears the number of reception times for that entry in the first table 71 to zero (step S49). Here, “Yes” is set as the value for that entry in the column of the presence or absence of the reset in the first table 71. The processing then moves to step S51.

By carrying out the processing described above, the different ports are finally registered in the second table 73, however, the processing such as illustrated in FIG. 2A and FIG. 2B is carried out.

### Embodiment 3

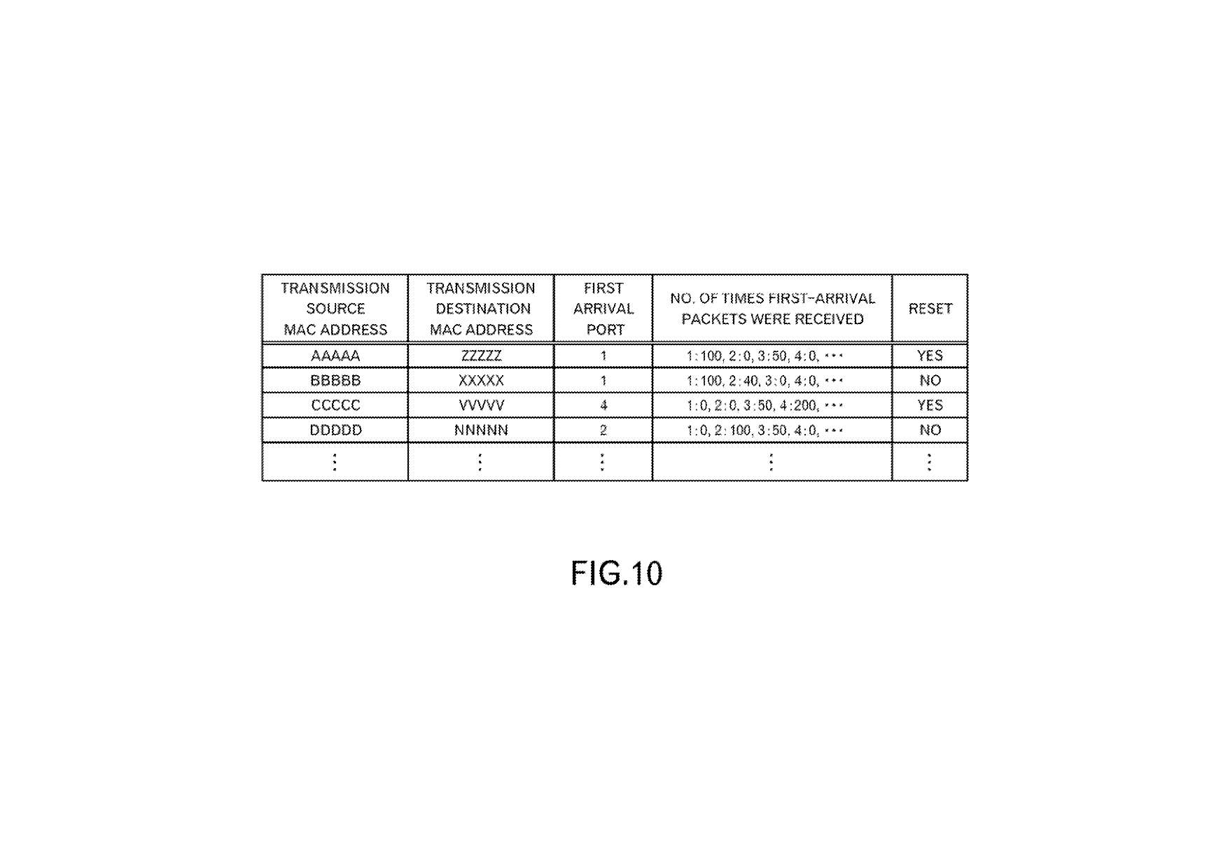

In this embodiment, part of the processing in the embodiment 1 is changed. The basic configuration of the switch 10 is the same, and part of the processing contents executed by the packet processing unit 5 is different. Moreover, part of the data in the first table 71 is also different. More specifically, FIG. 10 illustrates an example of a first table 71b of this embodiment. In the example in FIG. 10, the port at which the earliest first-arrival packet arrived (first arrival port), the number of times that the first-arrival packets have been received for each port, and whether or not the number of reception times has been cleared are registered for each combination of the transmission destination MAC address and transmission source MAC address.

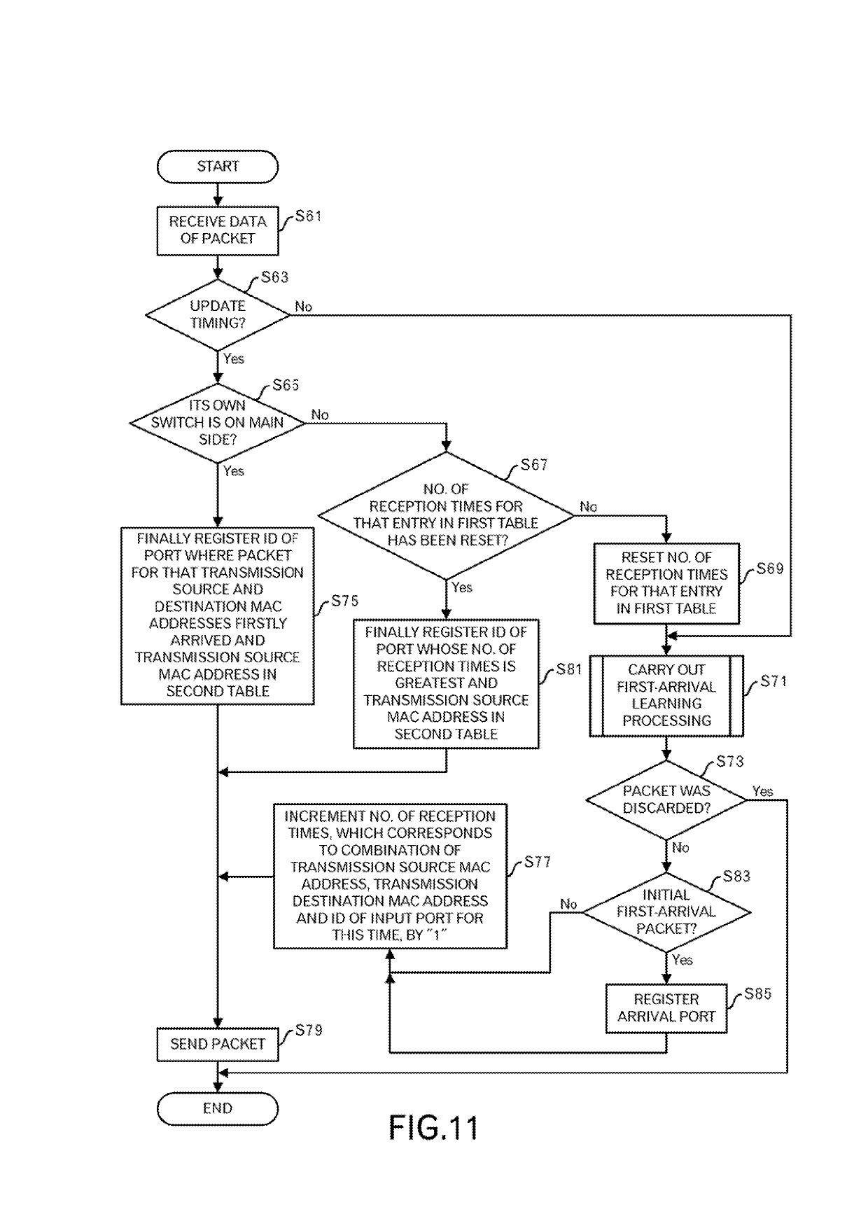

The processing executed by the packet processing unit 5 and the like will be explained using FIG. 11.

After receiving data of the packet from the MAC processing unit 3 (FIG. 11: step S61), the packet processing unit 5 identifies an entry that is registered in the first table 71b by using the transmission destination MAC address and the transmission source MAC address for that packet, and determines whether or not this timing is an update timing to update the second table 73 (step S63). For example, the packet processing unit 5 determines whether or not the total number of reception times of the first-arrival packets for the respective ports has reached a threshold value or greater. Moreover, when the reception time of the earliest first-arrival packet is registered, the packet processing unit 5 determines whether or not a predetermined amount of time has elapsed since that reception time.

When the timing is not the update timing, the packet processing unit 5 carried out the first-arrival learning processing (step S71). The first-arrival learning processing is the same as the processing illustrated in FIG. 8, so an explanation is omitted.

After the first-arrival learning processing, the packet processing unit 5 determines whether or not the packet was discarded during the first-arrival learning processing (step S73), and when the packet was discarded, the processing ends.

On the other hand, when the packet was not discarded, the packet processing unit 5 determines whether or not there is an entry in the first table 71b for the combination of the transmission destination MAC address and the transmission source MAC address, and when there is the entry, the packet processing unit 5 determines whether or not the packet received this time is the earliest first-arrival packet (step S83). When the packet that was received this time is not the earliest first-arrival packet, the processing moves to step S77. On the other hand, when the packet that was received this time is the earliest first-arrival packet, the packet processing unit 5 registers the identifier of the port at which the packet arrived this time in association with the transmission destination MAC address and transmission source MAC address in the first table 71b (step S85). The processing then moves to step the S77.

At the step S77, the packet processing unit 5 increments the number of reception times by “1” in the first table 71b, which corresponds to the transmission source MAC address, transmission destination MAC address and identifier of the input port for this time (step S77). Then, the packet processing unit 5 searches the second table 73 for the transmission destination MAC address of the received packet, and when a port identifier is correlated in the second table 73 with the transmission destination MAC address, the packet processing unit 5 outputs the data of that packet by way of the MAC processing unit 3 so that the packet is outputted from that port of the port identifier (step S79). However, when there is no entry in the second table 73 for the transmission destination MAC address, the packet processing unit 5 outputs the data of that packet by way of the MAC processing unit 3 so that the packet is outputted to other ports other than the current arrival port. The processing then ends.

By repeating such a processing, the number of times that the first-arrival packets were received for each port is registered in the first table 71b as illustrated in FIG. 10.

Then, when it was determined at the step S63 that this timing is the update timing, or in other words, when the total number of times that the first-arrival packets have been received for the respective ports reaches a threshold value or greater, or when the reception time of the earliest first-arrival packet is registered and a predetermined amount of time has elapsed since that reception time, the packet processing unit 5 determines whether or not its own switch is on the main side (step S65). For example, the packet processing unit 5 compares the transmission source MAC address X with the transmission destination MAC address Y, and when the transmission source MAC address X is greater than the transmission destination MAC address Y, the packet processing unit 5 determines that its own switch is on the main side. The switch 10 on the sub side compares the transmission source MAC address Y with the transmission destination MAC address X, and it is determined that the aforementioned condition is not satisfied and the switch 10 is recognized as being on the sub side.

When the switch is on the main side, the packet processing unit 5 finally registers the identifier of the port at which the earliest first-arrival packet arrived and which is registered in association with the transmission destination MAC address and transmission source MAC address for the packet received this time in the first table 71b, in association with the transmission source MAC address in the second table 73 (step S75). As a result, as for the switch 10 on the main side, the output destination port is fixed to the port where the earliest first-arrival packet arrived. The processing then moves to step S79.

On the other hand, in the case of the switch 10 on the sub side, the packet processing unit 5 determines whether or not the number of reception times in that entry in the first table 71b has already been reset before (step S67). This is determined from the value in the column of the presence or absence of the reset (Yes/No) for that entry in the first table 71b. When the number of reception times for that entry has already been reset before, the packet processing unit 5 finally registers the identifier of the port, which has the greatest number of reception times, which is correlated in the first table 71b with the transmission destination MAC address and transmission source MAC address, in association with the transmission source MAC address in the second table 73 (step S81). The processing then moves to step S79.

On the other hand, when the number of reception time for that entry has not been reset before, the packet processing unit 5 clears the number of reception times for that entry in the first table 71b to zero (step S69). Here, the packet processing unit 5 sets “Yes” for that entry in the column of the presence or absence of the reset in the first table 71b. The processing then moves to step S71.

By performing the processing such as described above, the different ports are finally registered in the second table 73, however, the processing such as illustrated in FIG. 2A and FIG. 2B is carried out.

### Embodiment 4

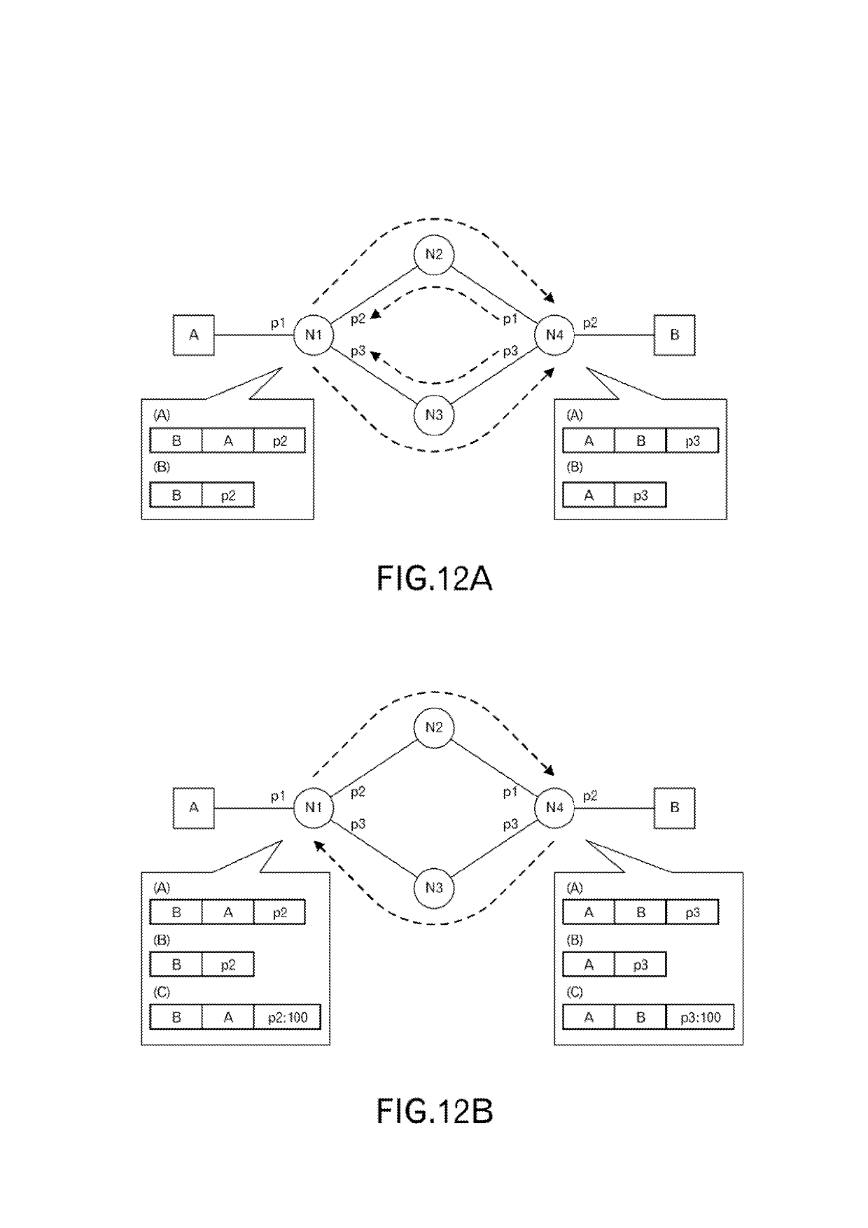

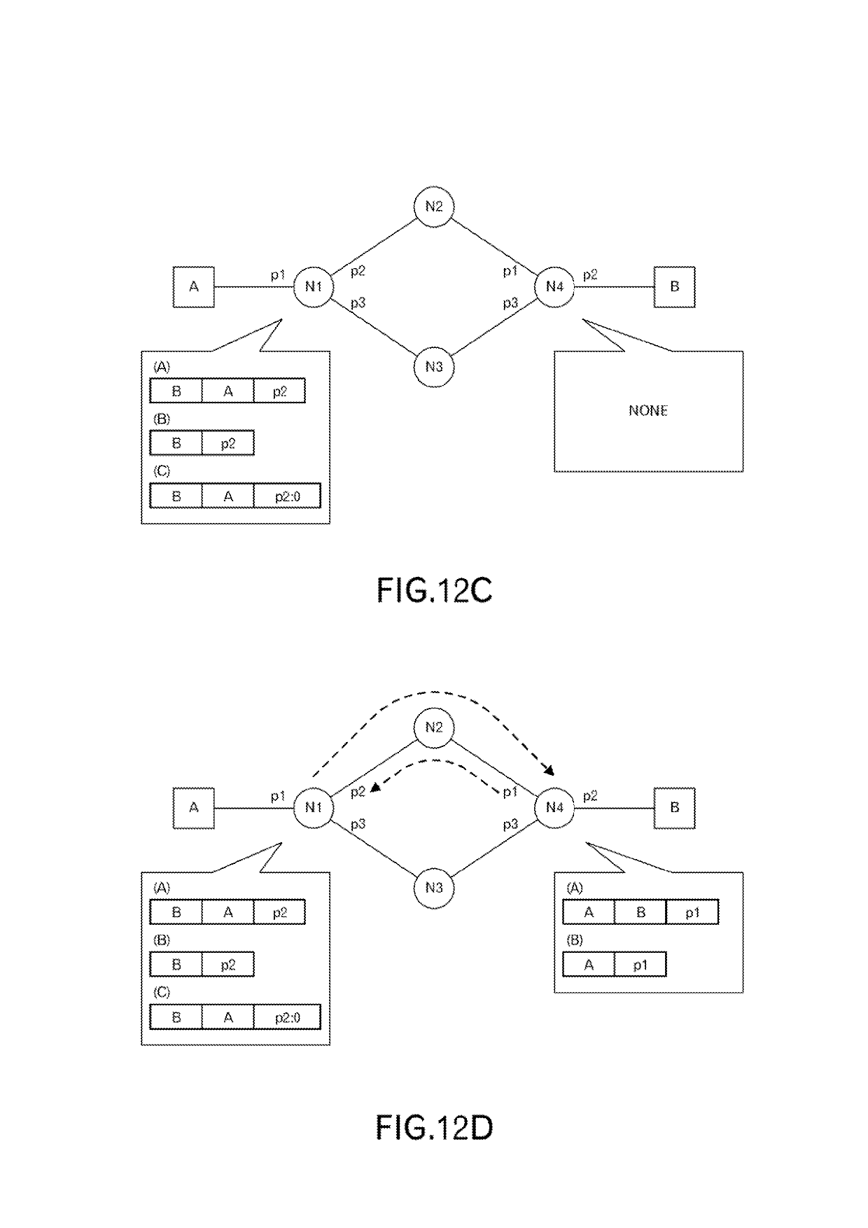

In this embodiment, the processing such as illustrated in FIG. 12A to 12D is carried out. First, a network including switches N1 to N4 is provided between a terminal A and a terminal B, where an edge switch on the terminal A side is the switch N1, and an edge switch on the terminal B side is the switch N4. Between the terminal A and the terminal B, there is a first path by way of the switches N1, N2 and N4, and a second path by way of the switches N1, N3 and N4. In such a network, it is presumed that the terminal A and terminal B perform the packet transmission from the terminal A to the terminal B and from the terminal B to the terminal A at nearly the same time. Initially, for any one of the switches N1 and N4, the correlation between the transmission destination MAC address and the port number has not been registered in a MAC learning table yet, so flooding (simultaneous transmission) is carried out, and as illustrated by the dotted lines in FIG. 12A, packets are transmitted in both directions through both the first path and the second path.

In such a case, when the switch N4 received the same packets at the port p1 and port p3, the switch N4 outputs only the first-arrival packet that arrived the earliest to the port p2, and discards the packet that arrived later. Then, the switch N4 registers the identifier of the port that received the first-arrival packet in association with the transmission source MAC address and transmission destination MAC address in a first-arrival table. As a result, after this, the switch N4 discards packets that include these transmission source MAC address and transmission destination MAC address even when packets are received at a port other than the port that received the first-arrival packet. Here, as illustrated in balloon (A), it is assumed that transmission source MAC address A, transmission destination MAC address B and port identifier p3 are registered. Furthermore, as illustrated in balloon (B), the transmission source MAC address A and arrival port p3 of the first-arrival packet are registered in the MAC learning table.

Similarly, when the switch N1 receives the same packets at the port p2 and port p3, the switch N1 outputs only the first-arrival packet that arrived the earliest to the port p1, and discards the packet that arrived later. Then, the switch N1 registers the identifier of the port that received the first-arrival packet in association with the transmission source MAC address and transmission destination MAC address in the first-arrival table. As a result, after this, the switch N1 discards packets that include these transmission source MAC address and transmission destination MAC address, even when packets are received at a port other than the port that received the first-arrival packet. Here, as illustrated in balloon (A), it is assumed that transmission source MAC address B, transmission destination MAC address A and port identifier p2 are registered. Furthermore, as illustrated in balloon (B), the transmission source MAC address B and arrival port p2 of the first-arrival packet are registered in the MAC learning table.

As a result, as illustrated in FIG. 12B, when a packet is transmitted next from the terminal A to the terminal B, the first path is selected at the switch N1, however, at the switch N4, the port p3 is set as receiving the packet in the first-arrival table, so the packet that arrives at the port p1 is discarded. Similarly, when a packet is transmitted next from the terminal B to the terminal A, the second path is selected at the switch N4, however, at the switch N1, the port p2 is set as receiving the packet in the first-arrival table, so the packet that arrives at the port p3 is discarded.

In this embodiment, the number of times that packets are discarded (i.e. the number of discarded packets) is correlated with the transmission destination MAC address, the transmission source MAC address and the identifier of the arrival port, and is counted. As illustrated in balloon (C), at the switch N4, the number of times that the packets are discarded is counted for a combination of the transmission source MAC address A, transmission destination MAC address B, and port identifier p3. Similarly, as illustrated in balloon (C), at the switch N1, the number of times that the packets are discarded is counted for a combination of the transmission source MAC address B, transmission destination MAC address A, and port identifier p2.

Here, for example, when comparing the MAC address of the terminal B and the MAC address of the terminal A, and that of the terminal B is greater, the edge switch N4 of the terminal B is given priority. As a result, for example, when the number of times that the packets are discarded reaches a threshold value or greater, the switch N4 on the main side deletes data related to the transmission source MAC address and transmission destination MAC address of the packet that was received and discarded this time. As illustrated in balloon in FIG. 12C, the data of (A) to (C) is deleted.

On the other hand, for example, as illustrated in balloon (C), when the number of times that the packets are discarded reaches the threshold value or greater, the switch N1 on the subside clears the number of times that the packets are discarded, which is correlated with the transmission source MAC address and the transmission destination MAC address of the packet that was received and discarded this time, to “0”.

After that, as illustrated in FIG. 12B, the packet transmission from the terminal A to the terminal B is carried out along the first path, so at the switch N4, the packet arrives at the port p1. As a result, this packet is outputted to the port p2. Then, as illustrated in balloon (A) in FIG. 12D, the identifier p1 of the port that received this packet is registered in association with the transmission source MAC address A and transmission destination MAC address B in the first-arrival table. Furthermore, as illustrated in balloon (B), the transmission source MAC address A and port p1 where the first-arrival packet arrived are registered in the MAC learning table.

As a result, when the packet transmission from the terminal B to the terminal A is carried out, at the switch N1, packets arrive at the port p2. This is as illustrated in the first-arrival table ((A) of FIG. 12D), so this packet is outputted to the port p1. In other words, the communication is enabled.

In doing as described above, the communication paths are unified.

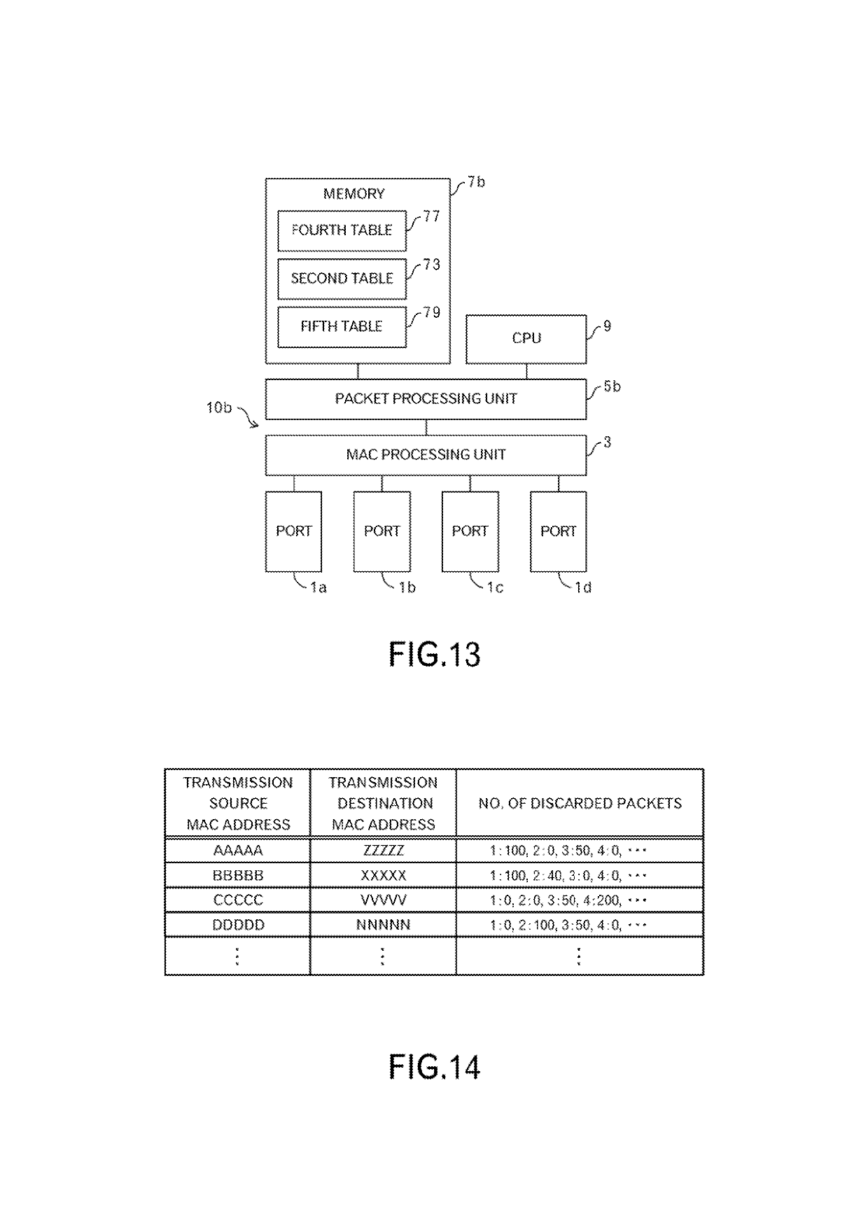

Next, FIG. 13 illustrates the configuration of a switch for performing such a processing. The same reference numbers are used for elements that are the same as those of the switch 10 in the first embodiment illustrated in FIG. 3.

The switch 10b of this embodiment has the plural ports 1 (four ports, 1a, 1b, lc and 1d in FIG. 13), each of which includes input ports and output ports, the MAC processing unit 3, a packet processing unit 5b, a memory 7b and the CPU (Central Processing Unit) 9.

The packet processing unit 5b carries out a main portion of the processing explained using FIG. 12A to FIG. 12D, and carries out a packet transfer processing to identify an output port from the transmission destination MAC address to output the packet. The memory 7b stores a fourth table 77 (also called a port learning table) for counting the number of times that packets are discarded for each port, a second table 73 (also called a MAC learning table) to correlate the transmission destination MAC address with the port identifier, and a fifth table 79 (also called the first-arrival table) to correlate a transmission source MAC address, transmission destination MAC address, port identifier and reception time.

FIG. 14 illustrates an example of the fourth table 77. In the example in FIG. 14, the number of times that packets have been discarded for each port is registered for each combination of the transmission destination MAC address and transmission source MAC address. For example, the example in FIG. 14 illustrates that first-arrival packets from AAAAA to ZZZZZ have been discarded 100 times for the port 1, “0” times for the port 2, “50” times for the port 3 and “0” times for the port 4.

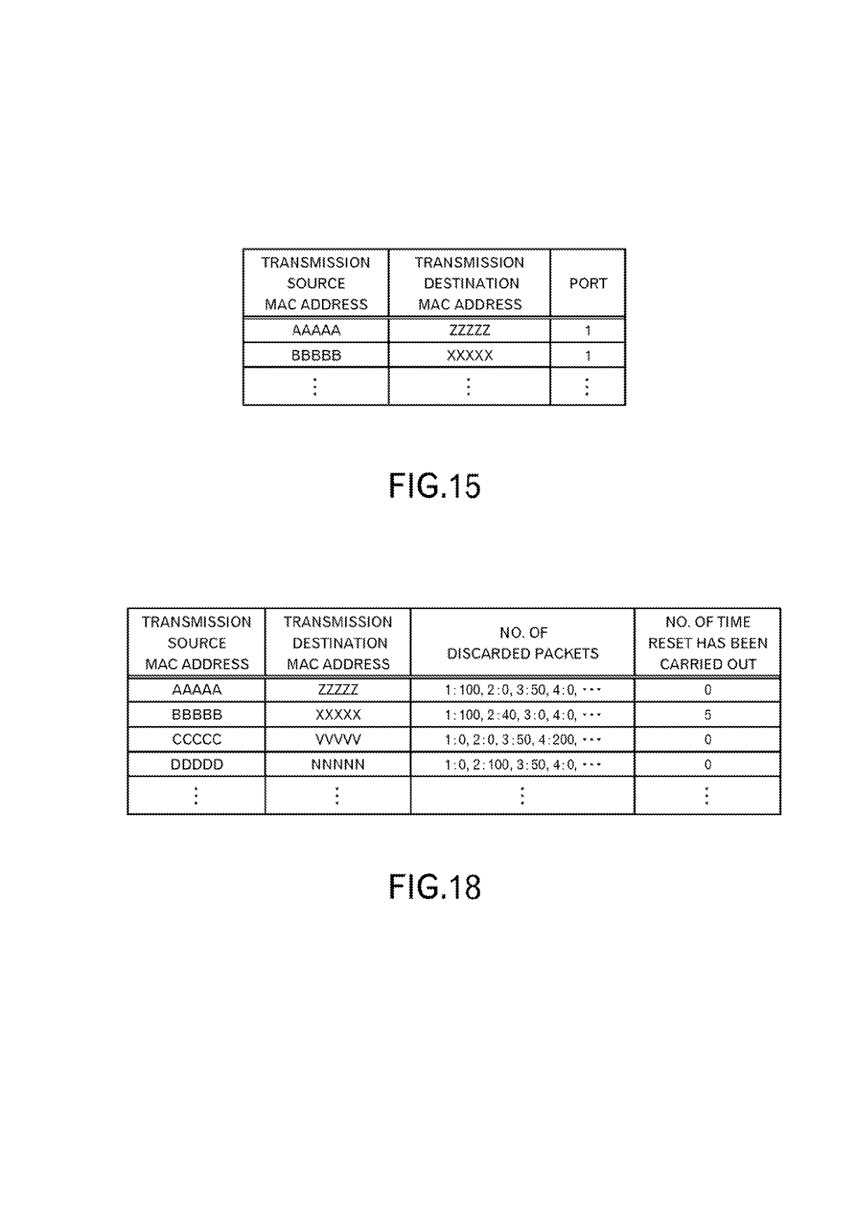

FIG. 15 illustrates an example of the fifth table 79. In the example in FIG. 15, an identifier of a port at which the first-arrival packet arrived (hereafter, referred to as a first-arrival port) is registered for each combination of the transmission destination MAC address and transmission source MAC address.

The second table 73 is the same as that of the first embodiment illustrated in FIG. 5.

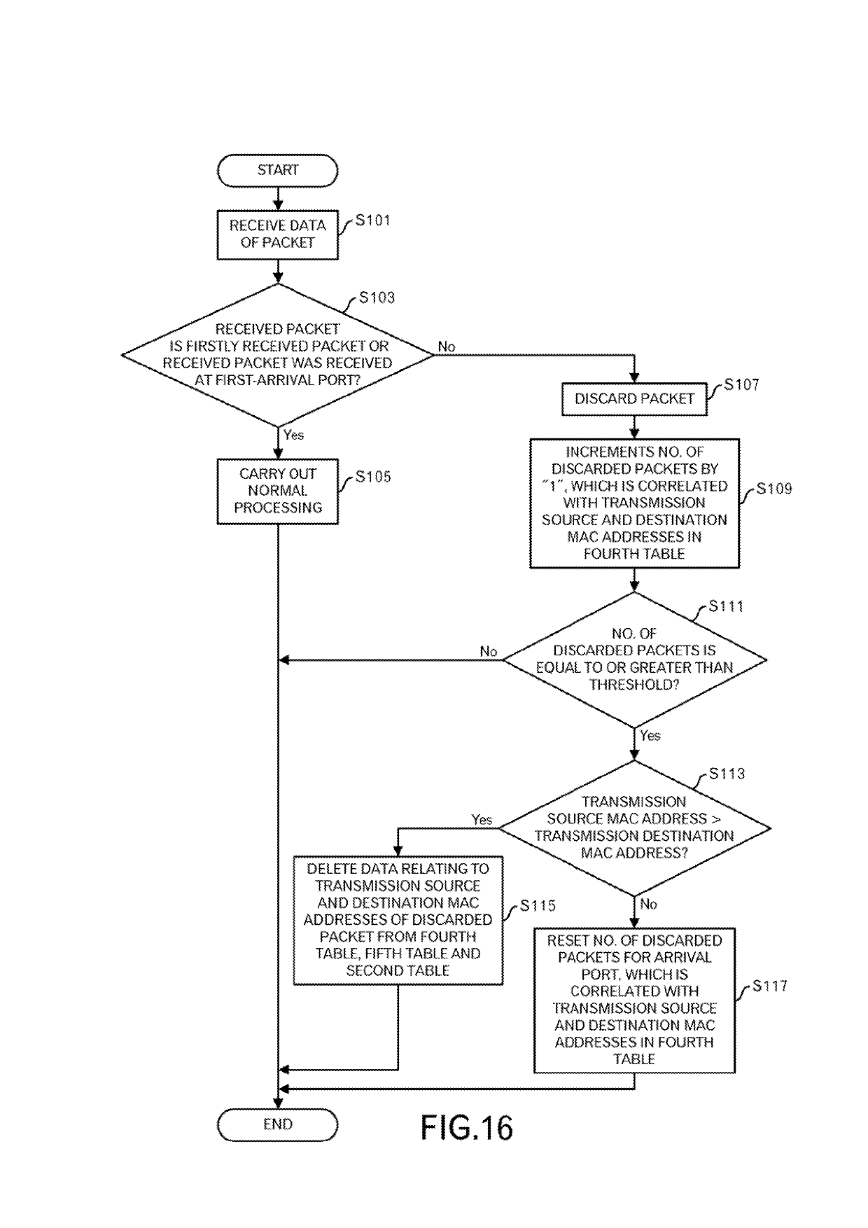

Next, FIG. 16 will be used to explain the processing contents of the processing executed by the packet processing unit 5b and the like. Data of a packet that is received by any one of the ports 1 is outputted to the packet processing unit 5b by way of the port 1 and the MAC processing unit 3. The data of the packet includes not only the data of the packet itself, but also an identifier of the input port where the packet arrived.

After receiving the data of the packet from the MAC processing unit 3 (FIG. 16: step S101), the packet processing unit 5b identifies an entry that is registered in the fifth table 79 for the transmission destination MAC address and transmission source MAC address for that packet, and determines whether or not the received packet is a first-arrival packet or whether or not the packet arrived at a first-arrival port (step S103). When there is an entry, the packet processing unit 5b determines whether or not the first-arrival port corresponding to the entry and the port where the received packet arrived are the same. When there is no entry, the packet is a first-arrival packet.

When the packet is a first-arrival packet, or when the received packet arrived at a first-arrival port, the packet processing unit 5b carries out a normal processing (step S105). When the packet is the first-arrival packet, the packet processing unit 5b registers the identifier of the port where the packet arrived in association with the transmission source MAC address and the transmission destination MAC address of that packet in the fifth table 79. Furthermore, the packet processing unit 5b also registers the identifier of the port where the packet arrived in association with the transmission source MAC address in the second table 73. Moreover, the packet processing unit 5b identifies, from the second table 73, the output destination port by using the transmission destination MAC address of the received packet, and causes the received packet to be outputted from that port. When the transmission destination MAC address is not registered in the second table 73, the flooding is carried out.

On the other hand, when the packet arrived at the first-arrival port, the packet processing unit 5b identifies, from the second table 73, the output destination port by using the transmission destination MAC address of the received packet, and causes the received packet to be outputted from that port. Then, the processing ends.

On the other hand, when the packet is not a first-arrival packet and arrived at a port other than the first-arrival port, the packet processing unit 5b discards the received packet (step S107). The packet processing unit 5b then increments, by “1”, the number of discarded packets for the arrival port of the discarded packet, which is correlated with the transmission source MAC address and the transmission destination MAC address of the discarded packet in the fourth table 77 (step S109). In the case that the transmission source MAC address and transmission destination MAC address are not registered in the fourth table 77, they are registered at this step.

The packet processing unit 5b then determines whether or not the incremented number of discarded packets has reached a threshold value or greater (step S111). When the number of discarded packets is less than the threshold value, the processing ends.

On the other hand, when the incremented number of discarded packets is equal to or greater than the threshold value, the packet processing unit 5b compares the transmission source MAC address X and the transmission destination MAC address Y of the discarded packet, and determines whether or not the transmission source MAC address X is greater than the transmission destination MAC address Y (step S113). When X>Y is satisfied, this switch is an edge switch on the main side, and the packet processing unit 5b deletes any data related to the transmission source MAC address and transmission destination MAC address of the discarded packet from the fourth table 77, fifth table 79 and second table 73 (step S115). The processing then ends.

With this processing, the entry associated with the transmission source MAC address and transmission destination MAC address is deleted from the fourth table 77 and fifth table 79, and the entry that includes the transmission source MAC address is deleted from the second table 73. As a result, a state of the switch 10b shifts to a state as if a packet that includes these transmission source MAC address and transmission destination MAC address has not been received. Therefore, when a packet arrives next time, which includes these transmission source MAC address and transmission destination MAC address, the processing of the step S105 will be performed. Then, after this processing has been carried out, in the stage of transmitting a packet in the opposite direction, the packet will be transmitted according to the second table 73 that was updated at the step S105.

On the other hand, when X<Y is satisfied, this switch is an edge switch on the sub side, and the packet processing unit 5b clears the number of discarded packets to zero for the arrival port in the fourth table 77, which is correlated with the transmission source MAC address and transmission destination MAC address of the discarded packet (step S117). However, this step may not be executed. The processing then ends.

By performing the processing such as described above, the processing illustrated in FIG. 12A to FIG. 12D is carried out, and the communication path is unified in both directions.

### Embodiment 5

This embodiment is a variation of the fourth embodiment. The basic configuration of the switch 10b is the same, and part of the processing contents of the processing executed by the packet processing unit 5b differs.

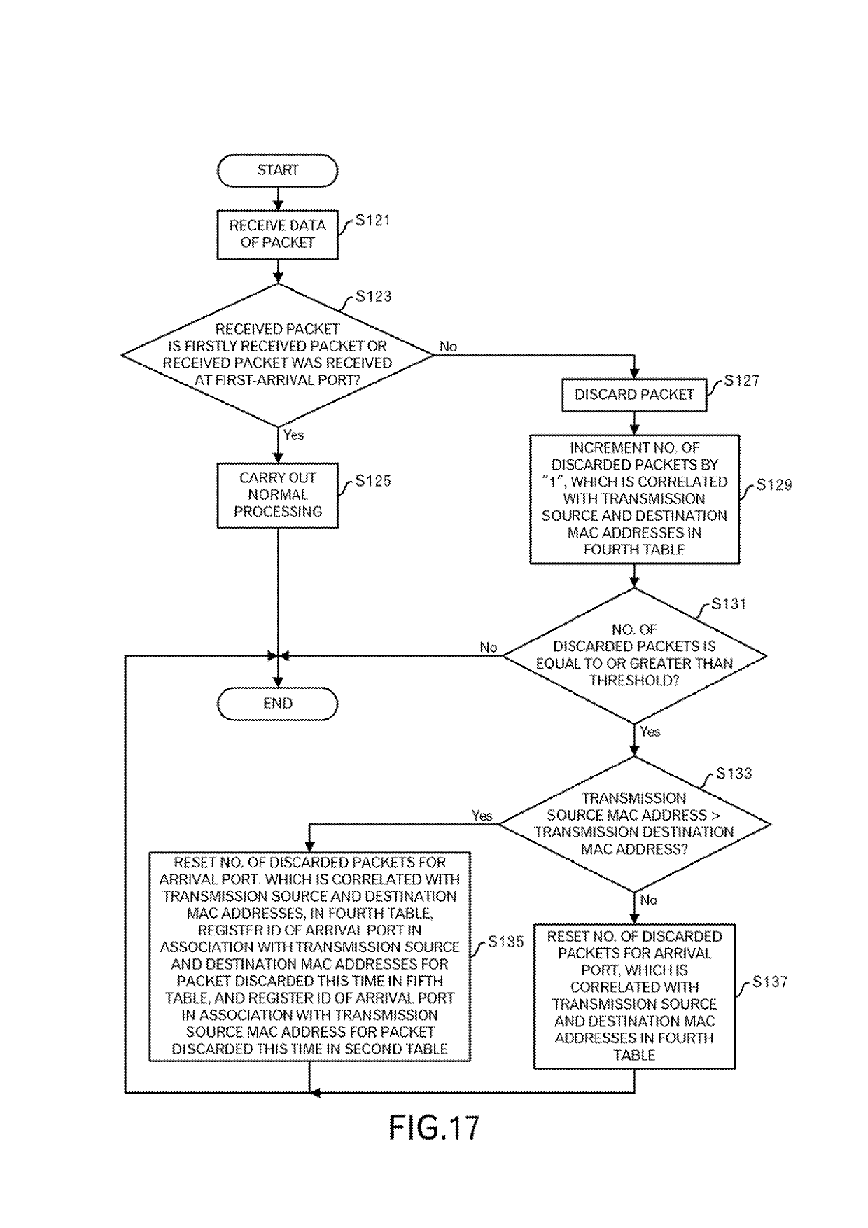

Next, the processing contents executed by the packet processing unit 5b and the like will be explained using FIG. 17. After receiving data of a packet from the MAC processing unit 3 (FIG. 17: step S121), the packet processing unit 5b identifies an entry that is registered in the fifth table 79 by using the transmission destination MAC address and transmission source MAC address of that packet, and determines whether or not the received packet is a first-arrival packet or whether the packet arrived at a first-arrival port (step S123). When there is an entry, the packet processing unit 5b determines whether or not the corresponding first-arrival port in that entry and the port where the received packet arrived are the same. When there is no entry, the packet is a first-arrival packet.

When the packet is a first-arrival packet, or when the packet arrived at the first-arrival port, the packet processing unit 5b carries out the normal processing (step S125). When the packet is a first-arrival packet, the packet processing unit 5b registers the identifier of the port where the packet arrived in association with the transmission source MAC address and transmission destination MAC address of that packet in the fifth table 79. Furthermore, the packet processing unit 5b also registers the identifier of the port where the packet arrived in association with the transmission source MAC address in the second table 73. Moreover, the packet processing unit 5b identifies, from the second table 73, the output destination port by using the transmission destination MAC address of the received packet, and causes the received packet to be outputted from that port. When the transmission destination MAC address is not registered in the second table 73, the flooding is executed.

On the other hand, when the packet arrived at the first-arrival port, the packet processing unit 5b identifies, from the second table 73, the output destination port by using the transmission destination MAC address of that received packet, and causes the received packet to be outputted from that port. The processing then ends.

On the other hand, when the packet is not a first-arrival packet and the packet arrived at a port other than the first-arrival port, the packet processing unit 5b discards the received packet (step S127). The packet processing unit 5b then increments, by “1”, the number of discarded packets for the arrival port of the discarded packet, which is correlated with the transmission source MAC address and the transmission destination MAC address of the discarded packet in the fourth table 77 (step S129). In the case that the transmission source MAC address and transmission destination MAC address are not registered in the fourth table 77, they are registered at this step.

The packet processing unit 5b then determines whether or not the incremented number of discarded packets has reached a threshold value or greater (step S131). When the number of discarded packets is less than the threshold value, the processing ends.

On the other hand, when the incremented number of discarded packets is equal to or greater than the threshold value, the packet processing unit 5b compares the transmission source MAC address X and the transmission destination MAC address Y of the discarded packet, and determines whether or not the transmission source MAC address X is greater than the transmission destination MAC address Y (step S133). When X>Y is satisfied, this switch is an edge switch on the main side, and the packet processing unit 5b clears to zero the number of discarded packets for the arrival port that is correlated in the fourth table 77 with the transmission source MAC address and transmission destination MAC address, registers the identifier of the arrival port in association with the transmission source MAC address and the transmission destination MAC address of the packet that was discarded this time in the fifth table 79, and furthermore, registers the identifier of the arrival port in association with the transmission source MAC address of the packet that was discarded this time in the second table 73 (step S135). The processing then ends.

With this processing, when the number of discarded packets for the arrival port of the packet that was discarded this time is equal to or greater than a threshold value, there is a high possibility that the next packet will arrive at this port, so anticipating that the next packet will arrive at this port, such a state is set in advance. Therefore, even though a packet that includes the same transmission source MAC address and transmission destination MAC address may arrive next at the port where the packet that was discarded this time arrived, the next packet is also processed at the step S125. On the other hand, when a packet is transmitted in the opposite direction, a port that is different from before is registered in the second table 73, so at the step S125, the processing to update the second table 73 is not performed, and the packet is outputted according to the second table 73 from the port that was set at the step S135.

On the other hand, when X<Y is satisfied, this switch is an edge switch on the sub side, and the packet processing unit 5b clears the number of discarded packets for the arrival port to zero, which is correlated with the transmission source MAC address and transmission destination MAC address of the discarded packet in the fourth table 77 (step S137). However, this may not be performed. The processing then ends.

By performing the processing such as described above, except for the portion of setting the second table 73, fourth table 77 and fifth table 79 early, the same processing as illustrated in FIG. 12A to FIG. 12D is performed, and the communication path is unified in both directions.

### Embodiment 6

In this embodiment, part of the processing in the fourth embodiment has been changed. The basic configuration of the switch 10b is the same, and part of the processing contents executed by the packet processing unit 5b is different. Moreover, part of the data in fourth table 77 is also different. More specifically, FIG. 18 illustrates an example of the fourth table 77b of this embodiment. In the example in FIG. 18, the number of times that packets are discarded (i.e. the number of discarded packets) for each port and the number of times that the reset has been performed for each port are registered for each combination of the transmission destination MAC address and transmission source MAC address.

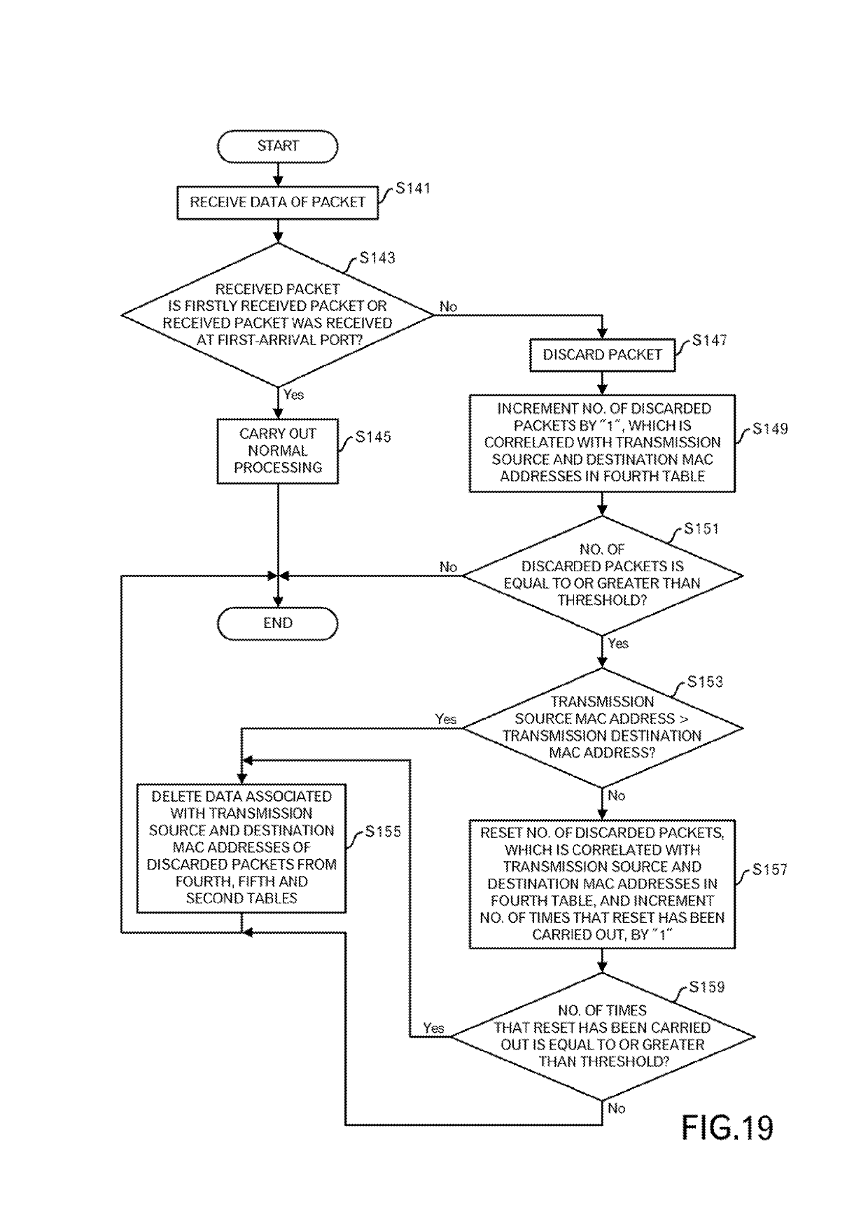

The processing performed by the packet processing unit 5b and the like will be explained using FIG. 19.

Data of a packet that was received by any one of the ports 1 is outputted to the packet processing unit 5b by way of the port 1 and the MAC processing unit 3. The data of the packet includes not only the packet data itself, but also an identifier of the input port where the packet arrived.

After receiving the data of the packet from the MAC processing unit 3 (FIG. 19: step S141), the packet processing unit 5b identifies an entry that is registered in the fifth table 79 by using the transmission destination MAC address and the transmission source MAC address of that packet, and determines whether or not the received packet is a first-arrival packet, or whether the packet arrived at the first-arrival port (step S143). When there is an entry, the packet processing unit 5b determines whether or not the corresponding first-arrival port and the port where the received packet arrived are the same. When there is no entry, the packet is a first-arrival packet.

When the packet is a first-arrival packet, or when the packet arrived at the first-arrival port, the packet processing unit 5b carries out the normal processing (step S145). When the packet is a first-arrival packet, the packet processing unit 5b registers the identifier of the port where the packet arrived in association with the transmission source MAC address and transmission destination MAC address of that packet in the fifth table 79. Furthermore, the packet processing unit 5b also registers the identifier of the port where the packet arrived in association with the transmission source MAC address in the second table 73. Moreover, the packet processing unit 5b identifies, from the second table 73, the output destination port by using the transmission destination MAC address of the received packet, and causes the received packet to be outputted from that port. When the transmission destination MAC address is not registered in the second table 73, the flooding is conducted.

On the other hand, when a packet arrived at the first-arrival port, the packet processing unit 5b identifies, from the second table 73, the output destination port by using the transmission destination MAC address of the received packet, and causes the received packet to be outputted from that port. The processing then ends.

On the other hand, when the packet is not a first-arrival packet and the received packet arrived at a port other than the first-arrival port, the packet processing unit 5b discards the received packet (step S147). Then, the packet processing unit 5b increments, by “1”, the number of discarded packets for the arrival port where the discarded packet arrived, which is correlated in the fourth table 77b with the transmission source MAC address and transmission destination MAC address of the discarded packet (step S149). When the transmission source MAC address and transmission destination MAC address are not registered in the fourth table 77b, they are registered at this step. Here, “0” is set as the number of times that the reset has been performed.

The packet processing unit 5b then determines whether or not the incremented number of discarded packets has reached a threshold value or greater (step S151). When the number of discarded packets is less than the threshold value, the processing ends.

On the other hand, when the incremented number of discarded packets has reached the threshold value or greater, the packet processing unit 5b compares the transmission source MAC address X and the transmission destination MAC address Y for the discarded packet, and determines whether or not the transmission source MAC address X is greater than the transmission destination MAC address Y (step S153). When X>Y is satisfied, this switch is an edge switch on the main side, and the packet processing unit 5b deletes any data related to the transmission source MAC address and transmission destination MAC address of the discarded packet from the fourth table 77b, fifth table 79 and second table 73 (step S155). The processing then ends.

With this processing, an entry that is correlated with the transmission source MAC address and transmission destination MAC address is deleted from the fourth table 77b and the fifth table 79, and an entry that includes the transmission source MAC address is deleted from the second table 73. As a result, a state of this switch 10b is shifted to a state in which a packet that includes those transmission source MAC address and transmission destination MAC address has not been received. Therefore, when a packet that includes these transmission source MAC address and transmission destination MAC address arrives next time, the processing of the step S145 is carried out. In the stage of transmitting a packet in the opposite direction after this processing has been performed, the packet is transmitted according to the second table 73 that was updated at the step S145.

On the other hand, when X<Y is satisfied, this switch is an edge switch on the sub side, and the packet processing unit 5b clears the number of discarded packets for the arrival port, which is correlated with the transmission source MAC address and transmission destination MAC address of the discarded packet in the fourth table 77b, to zero, and increments the number of times that the reset has been carried out, by “1” (step S157).

The packet processing unit 5b then determines whether or not the number of times that the reset has been carried out, which was incremented at the step S157, is equal to or greater than a threshold value (step S159). For example, when the number of times that packets are transmitted is about the same in both directions, the processing illustrated in FIG. 16 is sufficient, however, when the number of times that packets are transmitted from the edge switch on the sub side is much less, it may be difficult to shift the processing from the step S151 to the step S155, immediately. In order to handle such a case, the number of times that the reset has been carried out is counted, and when there is imbalance in the number of transmitted packets, the communication path is unified early by causing the edge switch on the sub side to function as the edge switch on the main side.

In other words, when the number of times that the reset has been carried out is equal to or greater than a threshold value, the processing moves to the step S155. On the other hand, when the number of times that the reset has been carried out is less than the threshold value, the processing ends.

By performing the processing such as described above, the same processing as illustrated in FIG. 12A to FIG. 12D is performed, and the communication path in both directions is unified. Furthermore, it is also possible to handle the case in which there is imbalance of the number of transmitted packets in the transmission direction.

### Embodiment 7

In this embodiment, part of the processing in the fifth embodiment is changed. The basic configuration of the switch 10b is the same, and part of the processing contents executed by the packet processing unit 5b is different. Moreover, part of the data in the fourth table 77 is also different. More specifically, the data is the same as in the fourth table 77b illustrated in FIG. 18.

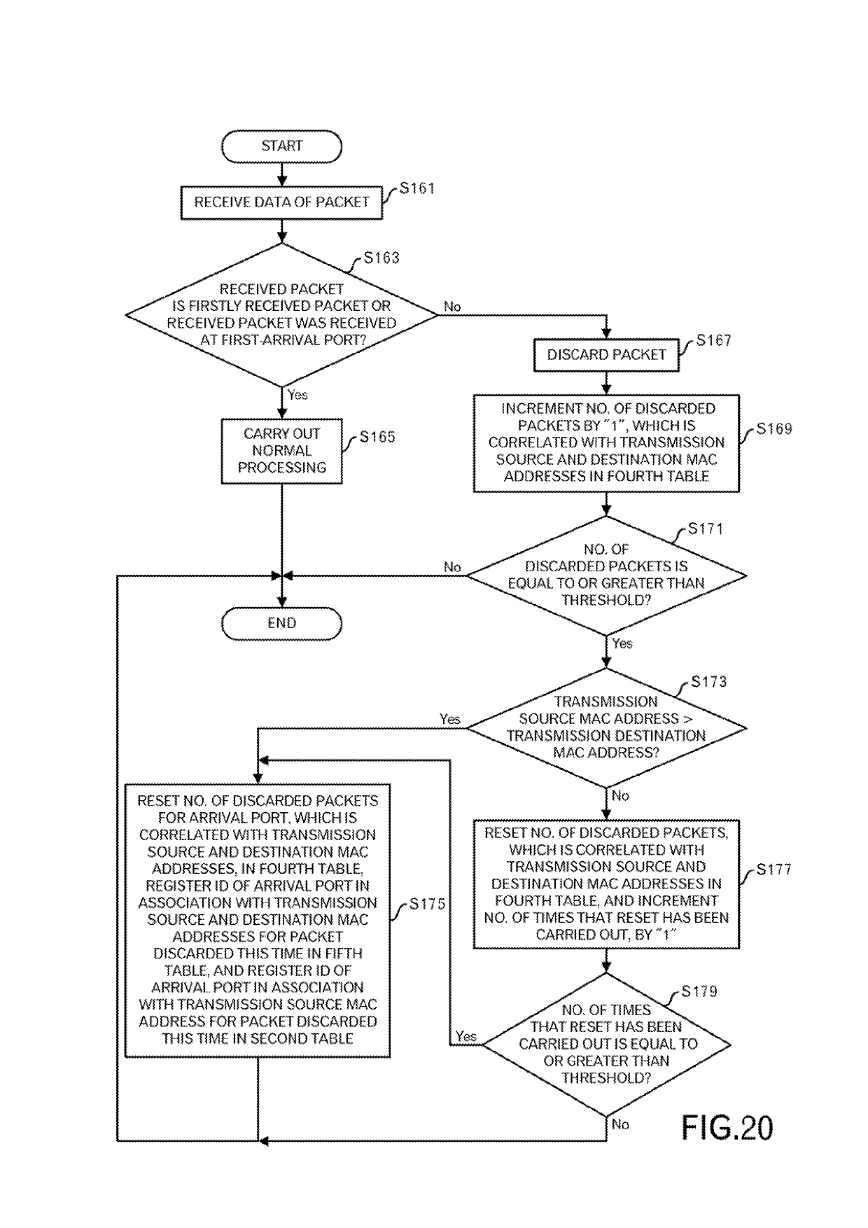

The processing carried out by the packet processing unit 5b and the like will be explained using FIG. 20.

Data of a packet, which is received by any one of the ports 1 is outputted to the packet processing unit 5b by way of the port 1 and the MAC processing unit 3. The data of the packet includes not only the packet data itself, but also an identifier for the input port where the packet arrived.

After receiving the data of the packet from the MAC processing unit 3 (FIG. 20: step S161), the packet processing unit 5b identifies an entry that is registered in the fifth table 79 by using the transmission destination MAC address and the transmission source MAC address of that packet, and determines whether or not the received packet is a first-arrival packet, or whether the packet arrived at the first-arrival port (step S163). When there is an entry, the packet processing unit 5b determines whether or not the corresponding first-arrival port in the entry and the port where the received packet arrived are the same. When there is no entry, the packet is a first-arrival packet.

When the packet is a first-arrival packet, or the when the packet arrived at the first-arrival port, the packet processing unit 5b carries out the normal processing (step S165). When the packet is a first-arrival packet, the packet processing unit 5b registers the identifier of the port where the packet arrived in association with the transmission source MAC address and transmission destination MAC address of that packet in the fifth table 79. Furthermore, the packet processing unit 5b also registers the identifier of the port where the packet arrived in association with the transmission source MAC address in the second table 73. Moreover, the packet processing unit 5b identifies, from the second table 73, the output destination port by using the transmission destination MAC address of the received packet, and causes the received packet to be outputted from that port. When the transmission destination MAC address is not registered in the second table 73, the flooding is carried out.

On the other hand, when a packet arrived at the first-arrival port, the packet processing unit 5b identifies, from the second table 73, the output destination port by using the transmission destination MAC address of the received packet, and causes the received packet to be outputted from that port. The processing then ends.

On the other hand, when the packet is not a first-arrival packet and the received packet arrived at a port other than the first-arrival port, the packet processing unit 5b discards the received packet (step S167). Then, the packet processing unit 5b increments, by “1”, the number of discarded packets for the arrival port where the discarded packet arrived, which is correlated in the fourth table 77b with the transmission source MAC address and transmission destination MAC address of the discarded packet (step S169). When the transmission source MAC address and transmission destination MAC address are not registered in the fourth table 77b, they are registered at this step. Here, “0” is set as the number of times that the reset has been performed.

The packet processing unit 5b then determines whether or not the incremented number of discarded packets has reached a threshold value or greater (step S171). When the number of discarded packets is less than the threshold value, the processing ends.

On the other hand, when the incremented number of discarded packets has reached the threshold value or greater, the packet processing unit 5b compares the transmission source MAC address X and the transmission destination MAC address Y of the discarded packet, and determines whether or not the transmission source MAC address X is greater than the transmission destination MAC address Y (step S173). When X>Y is satisfied, this switch is an edge switch on the main side, and the packet processing unit 5b clears, to zero, the number of discarded packets for the arrival port, which is correlated in the fourth table 77b with the transmission source MAC address and transmission destination MAC address, registers the identifier of the arrival port in association with the transmission source MAC address and transmission destination MAC address of the packet discarded this time in the fifth table 79, and registers the identifier of the arrival port in association with the transmission source MAC address of the packet discarded this time in the second table 73 (step S175). The processing then ends. The purpose of this step is the same as in the fifth embodiment.

On the other hand, when X<Y is satisfied, this switch is an edge switch on the sub side, and the packet processing unit 5b clears, to zero, the number of discarded packets for the arrival port, which is correlated with the transmission source MAC address and the transmission destination MAC address for the discarded packet in the fourth table 77b, and increments, by “1”, the number of times that the reset has been carried out (step S177).

The packet processing unit 5b then determines whether or not the number of times that the reset has been carried out, which was incremented at the step S177 is equal to or greater than a threshold value (step S179). The purpose of this is the same as in the sixth embodiment. In other words, when the number of times that the reset has been carried out is equal to or greater than the threshold value, the processing moves to the step S175. On the other hand, when the number of times that the reset has been carried out is less than the threshold value, the processing ends.

By performing the processing such as described above, except for the portion of setting the second table 73, fourth table 77b and fifth table 79 early, the same processing as illustrated in FIG. 12A to FIG. 12D is performed, and the communication path is unified in both directions. Furthermore, it is also possible to handle the case in which there is imbalance of the number of transmitted packets in the transmission direction.

Although the embodiments were explained above, this technique is not limited to those embodiments. For example, as long as the processing results do not change, the order of processing steps may be changed, or plural steps may be executed in parallel. Furthermore, in the aforementioned embodiments, the edge switches on the main side and the sub side carryout the same processing explained above, however, the processing flow may be different between the edge switch on the main side and the edge switch on the sub side. In such a case, the processing flow in FIG. 11 in the third embodiment may be changed, for example. In other words, in case of the edge switch on the main side, when an earliest first-arrival packet is received, an identifier of the port where the earliest first-arrival packet arrived may be immediately registered in the second table 73. Then, in case of the edge switch on the sub side, at the update timing, an identifier of the port whose number of reception times is the greatest may be registered in the second table 73 without the reset.

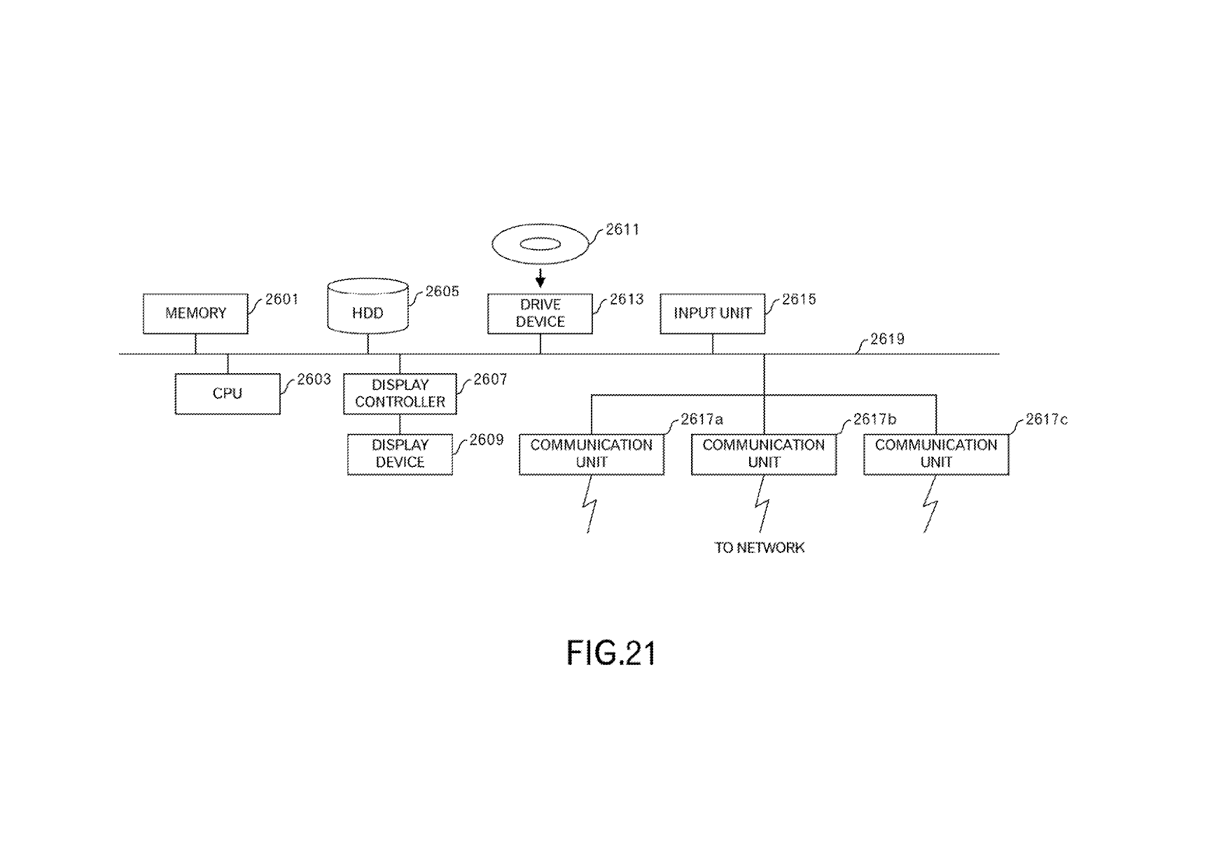

In addition, in each of the aforementioned switches, as illustrated in FIG. 21, a memory 2601, CPU 2603, Hard Disk Drive (HDD) 2605, display controller 2607 to be coupled with a display device 2609, drive device 2613 for a removable disk 2611, input device 2615 and communication units 2617 (2617a to 2617c in FIG. 21) for coupling to a network may be coupled with a bus 2619. Incidentally, according to circumstances, the display controller 2607, display device 2609, drive device 2613 and input device 2615 may not be included. The OS and application programs for carrying out a processing in these embodiments are stored in the HDD 2605, and read out from the HDD 2605 to the memory 2601 when being executed by the CPU 2603. If necessary, the CPU 2603 controls the display controller 2607, communication unit 2617 and drive device 2613 to carry out necessary operations. Incidentally, data that was inputted through any one of the communication units 2617 is outputted through another communication unit 2617. The CPU 2603 controls the communication units 2617 to appropriately switch output destinations. In addition, data during the processing is stored in the memory 2601, and stored in the HDD 2605 if necessary. In the embodiments of this technique, the application programs for carrying out the aforementioned processing are distributed by a computer-readable removable disk 2611 storing the application programs, and the application programs are installed into the HDD 2605 through the drive device 2613. The programs may be installed into the HDD 2605 through the communication unit 2617 and the network such as the Internet. Such a computer apparatus realizes the aforementioned various functions by cooperating the hardware such as the CPU 2603, memory 2601 and the like with the OS and the application programs if necessary.

The aforementioned embodiments are summarized as follows:

A communication apparatus relating to a first aspect of the embodiments includes: plural input ports; plural output ports, each of which corresponds to one different input port of the plural input ports; a memory storing first relation information, in which a transmission destination address and an identifier of an output port of an output destination are associated, and second relation information, in which a transmission destination address, a transmission source address, an identifier of an input port and the number of reception times; and a packet processing unit that identifies an identifier of an output port, which is associated with a transmission destination address of a received packet from any one input port of the plural input ports in the first relation information, and causes the received packet to be outputted to the output port of the identified identifier. Then, (A) upon receiving same packets at different input ports, the packet processing unit updates, in the second relation information, the number of reception times, which is associated with a transmission source address and a transmission destination address for the same packets and an identifier of an input port at which an earliest packet of the same packets arrived. Moreover, (B) upon detecting that a first timing condition is satisfied and in case where the communication apparatus is a first edge communication apparatus of two edge communication apparatuses associated with a transmission source address and a transmission destination address of a first received packet, the packet processing unit identifies an identifier of an input port based on the number of reception times, which is associated with the transmission source address and the transmission destination address of the first received packet in the second relation information, and updates the first relation information with an identifier of an output port corresponding to the identified identifier of the input port and the transmission source address of the first received packet. Furthermore, (C) upon detecting that the first timing condition is satisfied and in case where the communication apparatus is a second edge communication apparatus of the two edge communication apparatuses, the packet processing unit sets zero as the number of reception times, which is associated with the transmission source address and the transmission destination address of the first received packet in the second relation information. In addition, (D) upon detecting that a second timing condition is satisfied after the first timing condition is satisfied, in response to receipt of a second packet including the same transmission source address and the same transmission destination address of the first received packet, the packet processing unit identifies an identifier of an input port based on the number of reception times, which is associated with the transmission source address and the transmission destination address of the second packet in the second relation information, and updates the first relation information with an identifier of an output port corresponding to the identified identifier of the input port and the transmission source address of the second packet.

By doing so, the communication path is unified in both directions.

The aforementioned first timing condition may be a condition that a predetermined time elapsed after receiving an initial (or earliest) packet including the same transmission source address as the transmission source address of the first received packet and the same transmission destination address as the transmission destination address of the first received packet, or a condition that the number of reception times of first-arrival packets including the same transmission source address as the transmission source address of the first received packet and the same transmission destination address as the transmission destination address of the first received packet. It is possible to update the first table at an appropriate timing exceeds a threshold.

Moreover, the aforementioned second timing condition may be a condition that a second predetermined time elapsed after receiving an initial packet including the same transmission source address as the transmission source address of the first received packet and the same transmission destination address as the transmission destination address of the first received packet, or a condition that the number of reception times of first-arrival packets including the same transmission source address as the transmission source address of the first received packet and the same transmission destination address as the transmission destination address of the first received packet exceeds a threshold.

Furthermore, the aforementioned packet processing unit may identify an identifier of an input port whose number of reception times is maximum or identify an identifier of an input port whose number of reception times is minimum and not zero. As for the former, a path having the shortest delay time is selected, and as for the latter, a path that is not used so much is selected.

In addition, the aforementioned first edge communication apparatus may be determined based on a comparison result between the transmission source address and the transmission destination address of the first received packet. It becomes possible to simply determine what edge communication apparatus (e.g. edge switch) is the first edge communication apparatus.

A communication apparatus relating to a second aspect of the embodiments includes: plural input ports; plural output ports, each of which corresponds to one different input port of the plural input ports; a memory storing first relation information, in which a transmission destination address and an identifier of an output port of an output destination are associated, and second relation information, in which a transmission destination address, a transmission source address, an identifier of an input port and the number of reception times; and a packet processing unit that identifies an identifier of an output port, which is associated with a transmission destination address of a received packet from any one input port of the plural input ports in the first relation information, and causes the received packet to be outputted to the output port of the identified identifier. Then, (A) in case where the communication apparatus is a first edge communication apparatus of two edge communication apparatuses associated with a transmission source address and a transmission destination address of first received packets, the packet processing unit registers an identifier of an output port, which corresponds to an identifier of an input port at which an earliest packet of the first received packets arrived in the first relation information in association with the transmission source address of the first received packets, even when the first received packets are identical. Moreover, (B) in case where the communication apparatus is a second edge communication apparatus of the two edge communication apparatuses, the packet processing unit updates the number of reception times, which is associated in the second relation information with the transmission source address and the transmission destination address of the first received packets and an identifier of an input port at which one of the first received packets arrived, even when the first received packets are identical. In addition, (C) upon detecting that a first timing condition is satisfied, the packet processing unit identifies an identifier of an input port based on the number of reception times, which is associated with the transmission source address and the transmission destination address of the first received packets in the second relation information, and updates the first relation information with an identifier of an output port, which corresponds to the identified identifier of the input port and the transmission source address of the first received packets.

Even when such a configuration is adopted, the communication path is unified in both directions.

A communication apparatus relating to a third aspect of the embodiments includes: plural input ports; plural output ports, each of which corresponds to one different input port of the plural input ports; a memory storing first relation information, in which a transmission destination address and an identifier of an output port of an output destination are associated, second relation information, in which a transmission destination address, a transmission source address, an identifier of an input port and the number of discarding times, and third relation information, in which a transmission source address, a transmission destination address and an identifier of an input port; and a packet processing unit that identifies an identifier of an output port, which is associated with a transmission destination address of a received packet from any one input port of the plural input ports in the first relation information, and causes the received packet to be outputted to the output port of the identified identifier. Then, (A) upon detecting that a received packet arrived at an input port different from an input port, which is associated with a transmission source address and a transmission destination address of the received packet in the third relation information, the packet processing unit discards the received packet, and updates the number of discarding times, which is associated in the second relation information with the transmission source address and the transmission destination address of the received packet and an identifier of an input port at which the received packet arrived. Moreover, (B) upon detecting that the number of discarding times exceeds a threshold and in case where the communication apparatus is a first edge communication apparatus, which is identified based on a comparison result between a transmission source address and a transmission destination address of a discarded packet, among two edge communication apparatuses associated with the transmission source address and the transmission destination address of the discarded packets, the packet processing unit deletes information concerning the transmission source address and the transmission destination address of the discarded packet in the third relation information, at least the number of discarding times, which is associated in the second relation information, with the transmission source address and the transmission destination address of the discarded packet, and information concerning the transmission source address of the discarded packet in the first relation information.

Even when such a configuration is adopted, the communication path is unified in both directions.

Moreover, upon detecting that the number of discarding times exceeds the threshold and in case where the communication apparatus is a second edge communication apparatus, which is identified based on the comparison result between the transmission source address and the transmission destination address of the discarded packet, among the two edge communication apparatuses associated with the transmission source address and the transmission destination address of the discarded packets, the packet processing unit may set zero as the number of discarding times, which is associated with the transmission source address and the transmission destination address of the discarded packet in the second relation information.

Moreover, the number of times that reset for the number of discarding times has been carried out may be further associated in the second relation information. In addition, upon detecting the number of times that reset for the number of discarding times has been carried out exceeds a second threshold, the packet processing unit may delete data to determine identity for the discarded packet, at least the number of discarding times, which is associated with the transmission source address and the transmission destination address of the discarded packet in the second relation information, and information concerning the transmission source address of the discarded packet in the first relation information. By carrying out such a processing, even when there is imbalance of the number of communicated packets in the communication direction, it becomes possible to unify the communication path, appropriately.

A communication apparatus relating to a fourth aspect of the embodiments includes: plural input ports; plural output ports, each of which corresponds to one different input port of the plural input ports; and a memory storing first relation information, in which a transmission destination address and an identifier of an output port of an output destination are associated, second relation information, in which a transmission destination address, a transmission source address, an identifier of an input port and the number of discarding times, and third relation information, in which a transmission source address, a transmission destination address and an identifier of an input port; and a packet processing unit that identifies an identifier of an output port, which is associated with a transmission destination address of a received packet from any one input port of the plural input ports in the first relation information, and causes the received packet to be outputted to the output port of the identified identifier. Then, (A) upon detecting that a received packet arrived at an input port different from an input port, which is associated with a transmission source address and a transmission destination address of the received packet in the third relation information, the packet processing unit discards the received packet, and updates the number of discarding times, which is associated in the second relation information with the transmission source address and the transmission destination address of the received packet and an identifier of an input port at which the received packet arrived. Moreover, (B) upon detecting the number of discarding times exceeds a threshold and in case where the communication apparatus is a first edge communication apparatus, which is identified based on a comparison result between a transmission source address and a transmission destination address of a discarded packet, among two edge communication apparatuses associated with the transmission source address and the transmission destination address of the discarded packets, the packet processing unit discards at least the number of discarding times, which is associated with the transmission source address and the transmission destination address of the discarded packet in the second relation information, registers an identifier of an output port, which corresponds to an identifier of an input port at which the discarded packet arrived, in association with the transmission source address of the discarded packet in the first relation information, and registers the identifier of the output port, which corresponds to the identifier of the input port at which the discarded packet arrived, in association with the transmission source address and the transmission destination address of the discarded packet in the third relation information.

With this configuration, it becomes possible to unify the communication path in both directions in an early stage.

A control method relating to a fifth aspect of the embodiments includes: (A) upon receipt of same packets at different ports in an edge communication apparatus, counting the number of reception times for a port at which an earliest packet of the same packets was received, in association with a transmission source address and a transmission destination address of the same packets; (B) upon detecting that a first timing condition is satisfied, identifying, by using a first edge communication apparatus of two edge communication apparatuses relating to a received first packet, an identifier of a port based on the number of reception times, which is counted in association with a transmission source address and a transmission destination address of the received first packet, to store the identified identifier of the port in a memory of the first edge communication apparatus in association with the transmission source address of the received first packet; (C) upon detecting that the first timing condition is satisfied, clearing, by using a second edge communication apparatus of the two edge communication apparatuses, the number of reception times, which is counted in association with a transmission source address and a transmission destination address of a second packet transmitted in an opposite direction of the received first packet, and starting counting of the number of reception times again; and (D) upon detecting that a second timing condition is satisfied after the first timing condition is satisfied, identifying, by using the second edge communication apparatus, an identifier of a port based on the number of reception times, which is counted in association with the transmission source address and the transmission destination address of the second packet to store the identified identifier of the port in a memory of the second edge communication apparatus in association with the transmission source address of the second packet.

A control method relating to a sixth aspect of the embodiments includes: (A) storing, by using a first edge communication apparatus of two edge communication apparatuses relating to first packets received by the first edge communication apparatus, an identifier of a port, which received an earliest first packet of the first packets, in a memory of the first edge communication apparatus, in association with a transmission source address of the first packets, even when the first packets are identical; (B) upon receipt of second packets transmitted in an opposite direction of the first packets at different ports in a second edge communication apparatus of the two edge communication apparatuses, counting, by using the second edge communication apparatus, the number of reception times for a port at which an earliest packet of the second packets was received, in association with a transmission source address and a transmission destination address of the second packets; and (C) upon detecting that a first timing condition is satisfied, identifying, by using the second edge communication apparatus, an identifier of a port based on the number of reception times, which is counted in associated with the transmission source address and the transmission destination address of the second packets, to store the identified identifier of the port in a memory of the second edge communication apparatus in association with the transmission source address of the second packets.

A control method relating to a seventh aspect of the embodiments includes: (A) upon detecting that a received packet arrived at a port of an edge communication apparatus, which is different from a port associated with a transmission source address and a transmission destination address of the received packet in first relation information in which a transmission source address, a transmission destination address and an identifier of a port are associated, discarding, by using the edge communication apparatus, the received packet, and counting the number of discarded packets in association with the transmission source address and the transmission destination address of the received packet; and (B) upon detecting that the number of discarded packets exceeds a threshold, deleting, by using a first edge communication apparatus of two edge communication apparatuses relating to the transmission source address and the transmission destination address of the received packet, information concerning the transmission source address and the transmission destination address of the received packet in the first relation information, clearing a number of discarded packets for the transmission source address and the transmission destination address of the received packet, and deleting information concerning the transmission source address of the received packet in second relation information held in the first edge communication apparatus, in which a transmission destination address and an identifier of a port of an output destination are associated, wherein the first edge communication apparatus is identified based on a comparison result between the transmission source address and the transmission destination address of the received packet.

A control method relating to eighth aspect of the embodiments includes: (A) upon detecting that a received packet arrived at a port of an edge communication apparatus, which is different from a port associated with a transmission source address and a transmission destination address of the received packet in first relation information in which a transmission source address, a transmission destination address and an identifier of a port are associated, discarding, by using the edge communication apparatus, the received packet, and counting the number of discarded packets in association with the transmission source address and the transmission destination address of the received packet; and (B) upon detecting that the number of discarded packets exceeds a threshold, clearing, by using a first edge communication apparatus of two edge communication apparatuses relating to the transmission source address and the transmission destination address of the received packet, the number of discarded packets, which is counted in association with the transmission source address and the transmission destination address of the received packet, registering an identifier of a port at which the received packet arrived in association with the transmission source address of the received packet in second relation information held in the first edge communication apparatus, in which a transmission destination address and an identifier of a port of an output destination are associated, and registering the identifier of the port at which the received packet arrived in association with the transmission source address and the transmission destination address of the received packet in the first relation information, wherein the first edge communication apparatus is identified based on a comparison result between the transmission source address and the transmission destination address of the received packet.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory, and hard disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A communication apparatus, comprising:
a plurality of input ports;
a plurality of output ports, each of which corresponds to one different input port of the plurality of input ports;
a memory storing first relation information, in which a transmission destination address and an identifier of an output port of an output destination are associated, and second relation information, in which a transmission destination address, a transmission source address, an identifier of an input port and a number of reception times; and
a packet processing unit that identifies an identifier of an output port, which is associated with a transmission destination address of a received packet from any one input port of the plurality of input ports in the first relation information, and causes the received packet to be outputted to the output port of the identified identifier, and
wherein, upon receiving same packets at different input ports, the packet processing unit updates, in the second relation information, the number of reception times, which is associated with a transmission source address and a transmission destination address for the same packets and an identifier of an input port at which an earliest packet of the same packets arrived,
upon detecting that a first timing condition is satisfied and in case where the communication apparatus is a first edge communication apparatus of two edge communication apparatuses associated with a transmission source address and a transmission destination address of a first received packet, the packet processing unit identifies an identifier of an input port based on a number of reception times, which is associated with the transmission source address and the transmission destination address of the first received packet in the second relation information, and updates the first relation information with an identifier of an output port corresponding to the identified identifier of the input port and the transmission source address of the first received packet,
upon detecting that the first timing condition is satisfied and in case where the communication apparatus is a second edge communication apparatus of the two edge communication apparatuses, the packet processing unit sets zero as the number of reception times, which is associated with the transmission source address and the transmission destination address of the first received packet in the second relation information, and
upon detecting that a second timing condition is satisfied after the first timing condition is satisfied, in response to receipt of a second packet including the same transmission source address and the same transmission destination address of the first received packet, the packet processing unit identifies an identifier of an input port based on the number of reception times, which is associated with the transmission source address and the transmission destination address of the second packet in the second relation information, and updates the first relation information with an identifier of an output port corresponding to the identified identifier of the input port and the transmission source address of the second packet.

2. The communication apparatus as set forth in claim 1, wherein the first timing condition is a condition that a predetermined time elapsed after receiving an initial packet including the same transmission source address as the transmission source address of the first received packet and the same transmission destination address as the transmission destination address of the first received packet, or a condition that a number of reception times of first-arrival packets including the same transmission source address as the transmission source address of the first received packet and the same transmission destination address as the transmission destination address of the first received packet exceeds a threshold.

3. The communication apparatus as set forth in claim 1, wherein the second timing condition is a condition that a second predetermined time elapsed after receiving an initial packet including the same transmission source address as the transmission source address of the first received packet and the same transmission destination address as the transmission destination address of the first received packet, or a condition that a number of reception times of first-arrival packets including the same transmission source address as the transmission source address of the first received packet and the same transmission destination address as the transmission destination address of the first received packet exceeds a threshold.

4. The communication apparatus as set forth in claim 1, wherein the packet processing unit identifies an identifier of an input port whose number of reception times is maximum or identifies an identifier of an input port whose number of reception times is minimum and not zero.

5. The communication apparatus as set forth in claim 4, wherein the first edge communication apparatus is determined based on a comparison result between the transmission source address and the transmission destination address of the first received packet.

6. A communication apparatus, comprising:
a plurality of input ports;
a plurality of output ports, each of which corresponds to one different input port of the plurality of input ports;
a memory storing first relation information, in which a transmission destination address and an identifier of an output port of an output destination are associated, and second relation information, in which a transmission destination address, a transmission source address, an identifier of an input port and a number of reception times; and
a packet processing unit that identifies an identifier of an output port, which is associated with a transmission destination address of a received packet from any one input port of the plurality of input ports in the first relation information, and causes the received packet to be outputted to the output port of the identified identifier, and
wherein, in case where the communication apparatus is a first edge communication apparatus of two edge communication apparatuses associated with a transmission source address and a transmission destination address of first received packets, the packet processing unit registers an identifier of an output port, which corresponds to an identifier of an input port at which an earliest packet of the first received packets arrived in the first relation information in association with the transmission source address of the first received packets, even when the first received packets are identical,
in case where the communication apparatus is a second edge communication apparatus of the two edge communication apparatuses, the packet processing unit updates a number of reception times, which is associated in the second relation information with the transmission source address and the transmission destination address of the first received packets and an identifier of an input port at which one of the first received packets arrived, even when the first received packets are identical, and
upon detecting that a first timing condition is satisfied, the packet processing unit identifies an identifier of an input port based on the number of reception times, which is associated with the transmission source address and the transmission destination address of the first received packets in the second relation information, and updates the first relation information with an identifier of an output port, which corresponds to the identified identifier of the input port and the transmission source address of the first received packets.

7. A communication apparatus, comprising:
a plurality of input ports;
a plurality of output ports, each of which corresponds to one different input port of the plurality of input ports;
a memory storing first relation information, in which a transmission destination address and an identifier of an output port of an output destination are associated, second relation information, in which a transmission destination address, a transmission source address, an identifier of an input port and a number of discarding times, and third relation information, in which a transmission source address, a transmission destination address and an identifier of an input port; and
a packet processing unit that identifies an identifier of an output port, which is associated with a transmission destination address of a received packet from any one input port of the plurality of input ports in the first relation information, and causes the received packet to be outputted to the output port of the identified identifier, and
wherein, upon detecting that a received packet arrived at an input port different from an input port, which is associated with a transmission source address and a transmission destination address of the received packet in the third relation information, the packet processing unit discards the received packet, and updates a number of discarding times, which is associated in the second relation information with the transmission source address and the transmission destination address of the received packet and an identifier of an input port at which the received packet arrived, and
upon detecting that the number of discarding times exceeds a threshold and in case where the communication apparatus is a first edge communication apparatus, which is identified based on a comparison result between a transmission source address and a transmission destination address of a discarded packet, among two edge communication apparatuses associated with the transmission source address and the transmission destination address of the discarded packets, the packet processing unit deletes information concerning the transmission source address and the transmission destination address of the discarded packet in the third relation information, at least the number of discarding times, which is associated in the second relation information, with the transmission source address and the transmission destination address of the discarded packet, and information concerning the transmission source address of the discarded packet in the first relation information.

8. The communication apparatus as set forth in claim 7, wherein, upon detecting that the number of discarding times exceeds the threshold and in case where the communication apparatus is a second edge communication apparatus, which is identified based on the comparison result between the transmission source address and the transmission destination address of the discarded packet, among the two edge communication apparatuses associated with the transmission source address and the transmission destination address of the discarded packets, the packet processing unit sets zero as the number of discarding times, which is associated with the transmission source address and the transmission destination address of the discarded packet in the second relation information.

9. The communication apparatus as set forth in claim 8, wherein a number of times that reset for the number of discarding times has been carried out is further associated in the second relation information, and upon detecting the number of times that reset for the number of discarding times has been carried out exceeds a second threshold, the packet processing unit deletes data to determine identity for the discarded packet, at least the number of discarding times, which is associated with the transmission source address and the transmission destination address of the discarded packet in the second relation information, and information concerning the transmission source address of the discarded packet in the first relation information.

10. A communication apparatus, comprising:
a plurality of input ports;
a plurality of output ports, each of which corresponds to one different input port of the plurality of input ports;
a memory storing first relation information, in which a transmission destination address and an identifier of an output port of an output destination are associated, second relation information, in which a transmission destination address, a transmission source address, an identifier of an input port and a number of discarding times, and third relation information, in which a transmission source address, a transmission destination address and an identifier of an input port; and
a packet processing unit that identifies an identifier of an output port, which is associated with a transmission destination address of a received packet from any one input port of the plurality of input ports in the first relation information, and causes the received packet to be outputted to the output port of the identified identifier, and
wherein, upon detecting that a received packet arrived at an input port different from an input port, which is associated with a transmission source address and a transmission destination address of the received packet in the third relation information, the packet processing unit discards the received packet, and updates a number of discarding times, which is associated in the second relation information with the transmission source address and the transmission destination address of the received packet and an identifier of an input port at which the received packet arrived, and
upon detecting the number of discarding times exceeds a threshold and in case where the communication apparatus is a first edge communication apparatus, which is identified based on a comparison result between a transmission source address and a transmission destination address of a discarded packet, among two edge communication apparatuses associated with the transmission source address and the transmission destination address of the discarded packets, the packet processing unit discards at least the number of discarding times, which is associated with the transmission source address and the transmission destination address of the discarded packet in the second relation information, registers an identifier of an output port, which corresponds to an identifier of an input port at which the discarded packet arrived, in association with the transmission source address of the discarded packet in the first relation information, and registers the identifier of the output port, which corresponds to the identifier of the input port at which the discarded packet arrived, in association with the transmission source address and the transmission destination address of the discarded packet in the third relation information.

11. A control method, comprising:
upon receipt of same packets at different ports in an edge communication apparatus, counting a number of reception times for a port at which an earliest packet of the same packets was received, in association with a transmission source address and a transmission destination address of the same packets;
upon detecting that a first timing condition is satisfied, identifying, by using a first edge communication apparatus of two edge communication apparatuses relating to a received first packet, an identifier of a port based on a number of reception times, which is counted in association with a transmission source address and a transmission destination address of the received first packet, to store the identified identifier of the port in a memory of the first edge communication apparatus in association with the transmission source address of the received first packet;
upon detecting that the first timing condition is satisfied, clearing, by using a second edge communication apparatus of the two edge communication apparatuses, a number of reception times, which is counted in association with a transmission source address and a transmission destination address of a second packet transmitted in an opposite direction of the received first packet, and starting counting of the number of reception times again; and
upon detecting that a second timing condition is satisfied after the first timing condition is satisfied, identifying, by using the second edge communication apparatus, an identifier of a port based on the number of reception times, which is counted in association with the transmission source address and the transmission destination address of the second packet to store the identified identifier of the port in a memory of the second edge communication apparatus in association with the transmission source address of the second packet.

12. A control method, comprising:
storing, by using a first edge communication apparatus of two edge communication apparatuses relating to first packets received by the first edge communication apparatus, an identifier of a port, which received an earliest first packet of the first packets, in a memory of the first edge communication apparatus, in association with a transmission source address of the first packets, even when the first packets are identical;
upon receipt of second packets transmitted in an opposite direction of the first packets at different ports in a second edge communication apparatus of the two edge communication apparatuses, counting, by using the second edge communication apparatus, a number of reception times for a port at which an earliest packet of the second packets was received, in association with a transmission source address and a transmission destination address of the second packets; and
upon detecting that a first timing condition is satisfied, identifying, by using the second edge communication apparatus, an identifier of a port based on the number of reception times, which is counted in associated with the transmission source address and the transmission destination address of the second packets, to store the identified identifier of the port in a memory of the second edge communication apparatus in association with the transmission source address of the second packets.

13. A control method, comprising:
upon detecting that a received packet arrived at a port of an edge communication apparatus, which is different from a port associated with a transmission source address and a transmission destination address of the received packet in first relation information in which a transmission source address, a transmission destination address and an identifier of a port are associated, discarding, by using the edge communication apparatus, the received packet, and counting a number of discarded packets in association with the transmission source address and the transmission destination address of the received packet; and
upon detecting that the number of discarded packets exceeds a threshold, deleting, by using a first edge communication apparatus of two edge communication apparatuses relating to the transmission source address and the transmission destination address of the received packet, information concerning the transmission source address and the transmission destination address of the received packet in the first relation information, clearing a number of discarded packets for the transmission source address and the transmission destination address of the received packet, and deleting information concerning the transmission source address of the received packet in second relation information held in the first edge communication apparatus, in which a transmission destination address and an identifier of a port of an output destination are associated, wherein the first edge communication apparatus is identified based on a comparison result between the transmission source address and the transmission destination address of the received packet.

14. A control method, comprising:
upon detecting that a received packet arrived at a port of an edge communication apparatus, which is different from a port associated with a transmission source address and a transmission destination address of the received packet in first relation information in which a transmission source address, a transmission destination address and an identifier of a port are associated, discarding, by using the edge communication apparatus, the received packet, and counting a number of discarded packets in association with the transmission source address and the transmission destination address of the received packet; and
upon detecting that the number of discarded packets exceeds a threshold, clearing, by using a first edge communication apparatus of two edge communication apparatuses relating to the transmission source address and the transmission destination address of the received packet, the number of discarded packets, which is counted in association with the transmission source address and the transmission destination address of the received packet, registering an identifier of a port at which the received packet arrived in association with the transmission source address of the received packet in second relation information held in the first edge communication apparatus, in which a transmission destination address and an identifier of a port of an output destination are associated, and registering the identifier of the port at which the received packet arrived in association with the transmission source address and the transmission destination address of the received packet in the first relation information, wherein the first edge communication apparatus is identified based on a comparison result between the transmission source address and the transmission destination address of the received packet.
